(19) United States
(12) Patent Application Publication
(10) Pub. No.: US 2020/0079944 A1
(43) Pub. Date: Mar. 12, 2020

(54) COMPOSITION, PELLET, AND PROCESSES OF MAKING POLYPROPYLENE FOAMS

(71) Applicant: LCY CHEMICAL CORP., Kaohsiung City (TW)

(72) Inventors: Chiang-Hsiang LIN, Kaohsiung City (TW); Chi-Chung TSAO, Kaohsiung City (TW)

(21) Appl. No.: 16/527,136

(22) Filed: Jul. 31, 2019

Related U.S. Application Data
(60) Provisional application No. 62/728,155, filed on Sep. 7, 2018.

(30) Foreign Application Priority Data
Dec. 28, 2018 (CN) 201811631797.X

(51) Int. Cl. C08L 23/14; B29B 9/12; B29C 44/34

(52) U.S. Cl. CPC C08L 23/14; B29B 9/12; B29K 2023/12; B29B 2009/125; B29C 44/3403

(57) ABSTRACT

The present disclosure provides improved polypropylene-based compositions (formulations). The present disclosure further provides improved micro-pellets (non-foamed), which comprise the improved polypropylene-based composition. The improved polypropylene-based compositions have a reduced melting point (Tm) for the polypropylene resin while maintaining the stiffness of the micro-pellets for use in foaming procedures. Also, the disclosure further provides a new, dry method of preparing expanded polypropylene beads from micro-pellets without a liquid medium or steam, which thereby simplifies the production process and saves both energy and production costs.

### CROSS REFERENCE TO RELATED APPLICATION

This application claims the benefit of filing date of U.S. Provisional Application Ser. No. 62/728,155, filed Sep. 7, 2018 under 35 USC § 119(e)(1).

This application also claims the benefits of the Chinese Patent Application Serial Number 201811631797.X, filed on Dec. 28, 2018, the subject matter of which is incorporated herein by reference.

### BACKGROUND

### 1. Field of the Invention

The present disclosure relates to improved polypropylene-based compositions (formulations). The present disclosure additionally relates to improved micro-pellets (non-foamed), which comprise the improved polypropylene-based composition. The polypropylene-based compositions were formulated to reduce the melting point (Tm) of the polypropylene resin while maintaining the stiffness of the micro-pellets for use in foaming procedures. The present disclosure further relates to a new, dry method of preparing expanded polypropylene beads from micro-pellets without steam, which thereby simplifies the production process and saves both energy and production costs.

### 2. Description of Related Art

Polypropylene is a semi-crystalline material containing amorphous and ordered crystalline regions at room temperature. Depending on the crystallization conditions, polypropylene can crystallize into several crystalline forms. The most thermodynamically stable is the α or monoclinic form. Another crystalline form of polypropylene is the β or hexagonal form.

Expanded polypropylene (EPP) has a higher service temperature and better mechanical properties compared to those of expanded polystyrene (EPS) and expanded polyethylene (EPE). Expanded polypropylene is lightweight and recyclable and displays good surface protection and high resistance to oil, chemicals, and water. In addition, expanded polypropylene may be used, for example, in the automotive, packaging, and construction industries. Expanded polypropylene, like expandable polystyrene and expanded polyethylene, is widely-used for moldable bead foams. Bead-foamed molded parts of expanded polypropylene generally have excellent heat resistance, chemical resistance, and toughness as compared to bead-foamed molded parts of expanded polystyrene parts which are utilized for the same applications. However, in order to further expand and fusion-bond polypropylene beads in a mold cavity for polypropylene bead molding, it is necessary to use a higher temperature. That is, higher vapor pressures are needed for the production of polypropylene molded foam, (i.e., foamed molded products of expanded polypropylene beads), than is needed for use in the production of foamed molded products of expanded polystyrene beads. Because of the higher vapor pressure, the production of expanded polypropylene beads had required a mold having a highly pressure resistant structure, a specific molding apparatus of a high pressure pressing type, and a high energy cost.

To solve the need for high vapor pressures, JP-2000-894-A proposes coating polypropylene beads with a resin having a low melting point. In order to prepare such coated polypropylene beads, a complex apparatus and process are used. As an alternative solution, JP-H06-240041-A proposes the use of a polypropylene resin having a relatively low melting point, such as a polypropylene resin obtained using a metallocene polymerization catalyst comprising a transition metal component having a metallocene structure (e.g., ethylenebis(2-methylindenyl) zirconium dichloride) and an auxiliary catalyst component selected from an alumoxane, a Lewis acid, and an ionic compound. In general, a polypropylene resin produced using a metallocene catalyst can have a lower melting point than that produced using a Ziegler Natta catalyst. Moreover, JP-2006-96805-A discloses polypropylene beads made by mixing two polypropylene resins having a difference in melting temperature between 15 and 30° C., a melt flow rate (2.16 kg, 230° C.) of 3 to 20 g/10 min. The disclosed method of foaming polypropylene beads, however, requires a molding temperature of more than 140° C. That is, steam with a high vapor pressure must be used as a heating medium for molding the polypropylene beads.

Accordingly, there remains a need for improvement with respect to a reduction of the vapor pressure of steam used as a heating medium for in-mold molding of polypropylene beads, the appearance of the molded polypropylene beads, and the fusion-bonding efficiency of the molded polypropylene beads.

Currently, there are two commercial expanded polypropylene production methods. One method is known as the autoclave method, which is a batch process developed by companies such as, BASF and JSP. The other method is a continuous process known as the continuous twin-screw extruder method and developed by extruder makers (e.g., K M Berstorff). However, both of these known production methods require large investments in machinery and facilities. Moreover, the production efficiency of these two methods is not high.

A representative batch autoclave process for the production of expanded polypropylene beads comprises 4 steps. (E. K. Lee, Thesis of Doctor Degree, Novel Manufacturing Processes for Polymer Bead Foams, Department of Materials Science and Engineering, University of Toronto, 2010). In step 1 of the process, a polypropylene resin and desired additives (e.g., anti-oxidants, nucleating agents etc.) are compounded in an extruder and granulated into micro-pellets (non-foamed). Then, in step 2, these micro-pellets are conveyed to a stirred autoclave with a dispersion medium (i.e., a liquid medium), dispersing agent (e.g., tricalcium phosphate), surfactants (e.g., sodium dodecylarysulfonate), and a physical blowing agent (e.g., CO₂, butane) at an elevated pressure, and at a temperature above the melting point of the polypropylene resin. Then, in step 3, after suitable processing time has passed for the blowing agent to impregnate and foam the micro-pellets, the pressure is released to expand the pellets to make expanded polypropylene foam beads. At that point, the expanded polypropylene foam beads are cooled, washed and packed. The expanded polypropylene foam beads may then be sold and transported to steam-molding manufacturers. Finally, in step 4, the expanded polypropylene foam beads are conveyed to a molding machine (e.g., a steam chest molding machine) which uses steam to heat and fusion-bond the expanded polypropylene foam beads to form the final foamed, molded products.

The steam-chest molding technology uses a high-temperature steam to cause sintering of the EPP foam beads. The processing steam temperature in a steam-chest molding machine is coupled with the steam pressure. (Mills, N. J. Polymer Foams Handbook: Engineering and Biomechanics Application and Design Guide; Butterworth Heinemann: Oxford, 2007.) The EPP foam bead has a high melting point of about 150-170° C., as reflected by a peak on a DSC trace. Therefore, high steam temperatures and pressures are required for processing of EPP foam beads, which leads to a higher operating cost. And, the final physical and mechanical properties of the foamed, molded products depend on the strength of the inter-bead bonding. The inter-bead bonding is significantly affected by the molding conditions such as the steam pressure, steam temperature, and molding time. For example, if EPP foam beads are steamed for too long a time, their cell structure might collapse. (Stupak, P. R. et al. The Effect of Bead Fusion on the Energy Absorption of Polystyrene Foam. Part I: Fracture Toughness. J. Cell. Plast. 1991, 27, 484.)

Furthermore, a double-peak melting behavior on a DSC trace is required for EPP foam beads to achieve good sintering during the steam-chest molding. (Li Y. G. et al., Measurement of the PVT property of PP/CO₂ solution, Fluid Phase Equilibria, 2008, 270(1):15-22.) The steam-chest molding machine processes the EPP foam beads, and in this process, the crystals associated with a low melting point (Tm-low) melt and contribute to the fusion-bonding and sintering of individual EPP foam beads whereas unmelted high melting point (Tm-high) crystals help to preserve the overall cellular morphology of the bead foams. (Nofar, M. et al. Double Crystal Melting Peak Generation for Expanded Polypropylene Bead Foam Manufacturing. Ind. Eng. Chem. Res. 2013, 52, 2297.) Even a small variation in steam temperature may affect the Tm-high crystals and destroy the cellular morphology of the bead foams, and thus, result in shrinkage of the final foamed, molded product. The ratio between the low and high melting peaks, as reflected on a DSC trace, has been viewed as crucial in defining the surface quality and mechanical properties of the final foamed, molded products. (Guo, Y. et al. Critical Processing Parameters for Foamed Bead Manufacturing in a Lab-Scale Autoclave System. Chem. Eng. J. 2013, 214, 180.)

Given the high energy cost for the commercial foaming process of EPP foam beads, there remains a need for an improved polypropylene-based composition that not only leads to a reduction in the steam consumption cost from using lower pressure steam, but the EPP foam beads can also be expanded using an EPS, rather than EPP, foaming device without sacrificing the mechanical strength of the final foamed, molded products. Also, a steam-less molding process to simplify the existing commercial foaming process is desired as it would save energy and reduce the manufacturing costs.

### SUMMARY

It has surprisingly been found that improved polypropylene-based compositions (formulations) having a reduced melting point (Tm) for the polypropylene resin and yet maintain stiffness for micro-pellets (non-foamed) can be prepared by adjusting the C2 and/or C4 content of the polypropylene resin, namely random copolymer or terpolymer of polypropylene, as well as by adjusting the proportion of alpha (α) and beta (β) nucleating agents of the polypropylene-based composition. As used herein, “pellet” refers to normal size of polypropylene resin and “micro-pellet” refers to the reduced-size pellet before it is conveyed to an autoclave reactor (traditional, wet) or (new, dry) mold to control the size of the EPP foam beads. As used herein, “copolymer” refers to a polymer derived from two monomers and “terpolymer” refers to a polymer derived from three monomers. It has surprisingly been found that improved micro-pellets (non-foamed) for use in a foaming procedure, having a reduced melting point (Tm) for the polypropylene resin while maintaining its stiffness, can be achieved by adjusting the C2 and/or C4 content of the polypropylene resin, namely random copolymers or terpolymers of polypropylene, as well as by adjusting the proportion of α and β nucleating agents of the polypropylene-based composition.

The present disclosure additionally relates to micro-pellets (non-foamed), which comprise the improved polypropylene-based composition. The polypropylene-based compositions were formulated to reduce the melting point (Tm) of the polypropylene resin while maintaining the stiffness of the micro-pellets for use in foaming procedures.

A polypropylene-based composition comprising:

(a) a random copolymer of polypropylene in an amount of 95.98% to 99.97% by weight of the polypropylene-based composition, wherein the random copolymer of polypropylene is derived from monomers of propylene and one of ethylene and butylene; and

(b) at least one beta nucleating agent.

A polypropylene-based composition comprising:

(a) a random terpolymer of polypropylene in an amount of 94% to 99.97% by weight of the polypropylene-based composition,

wherein the random terpolymer of polypropylene is derived from monomers of propylene, ethylene, and butylene; and

(b) at least one beta nucleating agent.

A method for manufacturing polypropylene foam comprising:

a) extruding the polypropylene-based composition described above to form a non-foamed micro-pellet; and

b) foaming the non-foamed micro-pellet in a molding machine at a foaming pressure, a foaming temperature and a foaming time wherein the foaming pressure is in a range from 144 psi to 2050 psi, the foaming temperature is between a first and a second melting point of the polypropylene-based composition, and the foaming time is at least 5 minutes but not more than 30 minutes.

For example, an improved polypropylene-based composition may comprise a random copolymer of polypropylene, a β nucleating agent, and an α nucleating agent, with the random copolymer of polypropylene having specific amounts of one of ethylene (C2) (e.g., 0.01 wt % to 10 wt % based on a total weight of the random copolymer of polypropylene) and butylene (C4) (e.g., 0.01 wt % to 10 wt % based on a total weight of the random copolymer of polypropylene). As another example, an improved polypropylene-based composition may comprise a random terpolymer of polypropylene (propylene, ethylene, and butylene), a β nucleating agent, and optionally an α nucleating agent. In at least some embodiments, the C2 and C4 content of the random terpolymer of polypropylene is adjusted to improve the mechanical strength (e.g., tensile strength, tear strength, elongation @ break) of the final foamed, molded products. In at least one embodiment, the proportion of α nucleating agent (when present) relative to β nucleating agent is adjusted to maintain a low Tin of the resin and still increase the mechanical strength of the final foamed, molded products.

In at least some embodiments, the present disclosure provides improved polypropylene-based compositions comprising relatively low amounts of α and β nucleating agents alone or in combination. In some embodiments, the amount of 13 nucleating agent is higher than the amount of α nucleating agent. In another embodiment, at least a 4:1 ratio of 13 nucleating agent to α nucleating agent may be needed to achieve a composition with two melting points, as reflected by two peaks on a DSC trace. In at least one embodiment, a ratio of 2:1 β nucleating agent to α nucleating agent can still achieve a composition with two melting points. The disclosed polypropylene-based compositions allow the reduction of the melting point of the resin while maintaining the stiffness of the micro-pellets that are then used to make EPP foam beads in an autoclave reactor.

The disclosure further provides a new, pellet direct foaming (PDF) method, which simplifies the existing commercial foaming process. The disclosed PDF method is a steam-less molding of EPP foam beads comprising the steps of extruding the polypropylene-based composition to form micro-pellets (non-foamed), and directly molding the micro-pellets in a batch, physical foaming machine under conditions that differ from the known processes for foaming EPP foam beads. Namely, the PDF method operates at a lower foaming pressure, a lower foaming temperature, and a lower foaming time, with the foaming temperature between the two melting points (i.e., Tm-low (Tm2) and Tm-high (Tm1) as reflected by two peaks on a DSC trace) of the polypropylene-based composition. Advantageously, the disclosed PDF method does not have steps 2 and 3 discussed above, which are required of existing foaming methods with a batch, physical-foaming machine, such as batch autoclave process. That is, the disclosed PDF process does not require mixing in a liquid medium and then injecting gas in the autoclave for pellets impregnation (i.e., step 2). Thus, step 3 is also not required, namely after the pellets are well-foamed by the gas, the autoclave system is depressurized to make EPP foam beads. Nor do the EPP foam beads need to be dried before packaging.

Specifically, the disclosed PDF method does not include mixing in a liquid medium and steaming associated with forming conventional EPP foam beads before entering the molding machine (see FIG. 1A). Herein, the polypropylene resin is introduced into an inlet 111 of an extruder 11 to form polypropylene pellets 12. Next, a pressure reactor 13 is used to foam the polypropylene pellets 12, and foamed beads are obtained after dropping the pressure. Then, the foamed beads are introduced into a molding machine 14 to obtain a molding product. The exclusion of these steps is possible due to the improved polypropylene-based composition. As shown in FIG. 1B, in the disclosed PDF method, the improved polypropylene-based composition of the present disclosure is introduced into an inlet 111 of an extruder 11 to form polypropylene pellets 12. Then, the polypropylene pellets 12 are directly introduced into a molding machine 14 to obtain a molding product.

Random Copolymer of Polypropylene

In certain embodiments, the polypropylene-based composition comprises a random copolymer of polypropylene in an amount of at least 95.98% to 99.97% by weight of the polypropylene-based composition. In at least some embodiments, the polypropylene-based composition comprises a random copolymer of polypropylene in an amount chosen from 96%, 96.5%, 97%, 97.5%, 98%, 98.5%, 99%, 99.1%, 99.2%, 99.3%, 99.4%, 99.5%, 99.6%, 99.7%, 99.8%, and 99.9% by weight of the polypropylene-based composition. In at least one embodiment, the random copolymer of polypropylene is 99.75% by weight of the polypropylene-based composition. In another embodiment, the random copolymer of polypropylene is 99.9% by weight of the polypropylene-based composition.

In some embodiments, the random copolymer of polypropylene is derived from monomers of propylene (C3) and one of ethylene (C2) and butylene (C4). In at least some embodiments, the ethylene (C2) is present in an amount ranging from 0.01% to 10% by weight of the random copolymer of ethylene and propylene. In some embodiments, the ethylene (C2) is present in an amount ranging from 0.1% to 5% by weight of the random copolymer of ethylene and propylene. And, in other embodiments, the ethylene (C2) is present in an amount ranging from 2% to 4% by weight of the random copolymer of ethylene and propylene. In some embodiments, the ethylene (C2) is present in an amount ranging from 3% to 4% by weight of the random copolymer of ethylene and propylene. In another embodiment, butylene (C4) is present in an amount ranging from 0.01% to 10% by weight of the random copolymer of butylene and propylene. In some embodiments, the butylene (C4) is present in an amount ranging from 4% to 8% by weight of the random copolymer of ethylene and butylene.

In some embodiments, the polypropylene-based composition comprises at least one β nucleating agent. In certain embodiments, the β nucleating agent is chosen from NAB-82 and NU-100. NAB-82 is calcium tetrahydrophthalate, which is a type of β nucleating agent from Gchchem. NU-100 is N,N′-dicyclohexyl-2,6-naphthalene dicarboxamide, which is a type of β nucleating agent from New Japan Chemical Co., Ltd. In at least one embodiment, the β nucleating agent is NAB-82. In some embodiments, the at least one β nucleating agent is present in an amount ranging from 0.01% to 2% by weight of the polypropylene-based composition. In at least one embodiment, a β nucleating agent is present in an amount ranging from 0.1% to 1.5% by weight of the polypropylene-based composition. In one embodiment, the β nucleating agent is about 0.1% by weight of the polypropylene-based composition. In another embodiment, the β nucleating agent is about 0.2% by weight of the polypropylene-based composition.

In at least some embodiments, the polypropylene-based composition further comprises one or more α nucleating agents. In some embodiments, the α nucleating agent may be chosen from NA-11 and NX-8000. NA-11 is sodium 2,2′-methylene-bis-(4,6-di-t-butylphenylene) phosphate, which is a type of α nucleating agent, from ADEKA. NX-8000 is bis(4-propylbenzylidene) propyl sorbitol, which is a type of α nucleating agent from Milliken & Company. In at least one embodiment, the α nucleating agent is NX-8000. In some embodiments, the one or more α nucleating agents may be present in an amount ranging from 0.01% to 0.99% by weight of the polypropylene-based composition, but in an amount less than the β nucleating agent. In at least one embodiment, the one or more α nucleating agents may be present in an amount ranging from 0.1% to 0.99% by weight of the polypropylene-based composition, but in an amount less than the β nucleating agent. In one embodiment, the one or more α nucleating agents may be about 0.05% by weight of the polypropylene-based composition, but in an amount less than the β nucleating agent.

In some embodiments, the polypropylene-based composition has two melting points (i.e., two melting peaks as determined by Differential Scanning calorimetry (DSC) with a scan range from 30° C. to 190° C. at a rate of 10° C./min). In at least one embodiment, the two melting points are (i) a low melting point (Tm-low) of no less than 130° C. and (ii) a high melting point (Tm-high) of no more than 160° C. In some embodiments, the low melting point (Tm-low) may be in the range of 130° C. to 138° C. In one embodiment, the low melting point (Tm-low) is 136° C. In another embodiment, the low melting point (Tm-low) is 137° C. In some embodiments, the high melting point (Tm-high) may be in the range of 152° C. to 160° C. In some embodiments, the high melting point (Tm-high) is 153° C.

In other embodiments, the polypropylene-based composition further comprises one or more additives. In some embodiments, the one or more additives may be chosen from impact modifiers, polar modifiers, slip agents, anti-oxidants, and anti-acid agents. In at least some embodiments, a suitable impact modifier may be chosen from Engage 8150 and Engage 8401. Engage 8150 is a polyolefin elastomer of ethylene-octene copolymer from Dow Chemical. Engage 8401 is a polyolefin elastomer of ethylene-octene copolymer from Dow Chemical. In at least some embodiments, a suitable polar modifier may be chosen from Evaloy AC3427 and Lotryl 29MA03. Evaloy AC3427 is a copolymer of ethylene and butyl acrylate (27% butyl acrylate content) from Du Pont. Lotryl 29MA03 is a random copolymer of ethylene and methyl acrylate from Arkema. In at least some embodiments, a suitable slip agent may be chosen from MB50-001 and MB50-321. MB50-001 is an ultra-high molecular weight siloxane polymer, dispersed in polypropylene homopolymer (50% siloxane content) from Dow Corning. MB50-321 is an ultra-high molecular weight functionalized siloxane polymer dispersed in high flow polypropylene homopolymer (50% siloxane content) from Dow Corning. In at least some embodiments, a suitable anti-oxidant may be chosen from Irganox 1010 and Irgafos 168. Irganox 1010 is a sterically hindered primary phenolic antioxidant stabilizer from BASF. Irgafos 168 is a hydrolytically stable organo-phosphite processing stabilizer from BASF. In one embodiment, a suitable anti-acid agent is CaSt. In addition, the additive may comprise a thermoplastic elastomer, such as PEBAX from Arkema, SEBS from LCY Chemical Corp., TPEE from Chang Chun Petrochemical Co., Ltd. and Infuse OBC from Dow Chemical.

In one embodiment, a melt flow rate of the random copolymer may be in a ranged from 5 g/10 min to 10 g/10 min., for example, from 6 g/10 min to 10 g/10 min, from 7 g/10 min to 10 g/10 min, from 8 g/10 min to 10 g/10 min, from 5 g/10 min to 9 g/10 min, from 6 g/10 min to 9 g/10 min, from 7 g/10 min to 9 g/10 min or from 8 g/10 min to 9 g/10 min.

Random Terpolymer of Polypropylene

In some embodiments, the propylene-based composition comprises a random terpolymer of polypropylene in an amount of at least 94% to 99.97% by weight of the polypropylene-based composition. In some embodiments, the polypropylene-based composition comprises a random terpolymer of polypropylene in an amount chosen from 91%, 92%, 93%, 94%, 95%, 96%, 97%, 98%, and 99% by weight of the polypropylene-based composition. In at least some embodiments, the polypropylene-based composition comprises a random terpolymer of polypropylene in an amount chosen from 94%, 94.25%, 94.5%, 94.75%, 95%, 95.25%, 95.5%, 95.75%, 96%, 96.1%, 96.2%, 96.3%, 96.4%, 96.5%, 96.6%, 96.7%, 96.8%, 96.9%, 97%, 97.1%, 97.2%, 97.3%, 97.4%, 97.5%, 97.6%, 97.7%, 97.8%, 97.9%, 98%, 98.1%, 98.2%, 98.3%, 98.4%, 98.5%, 98.6%, 98.7%, 98.8%, 98.9%, 99%, 99.1%, 99.2%, 99.3%, 99.4%, 99.5%, 99.6%, 99.7%, and 99.8% by weight of the polypropylene-based composition.

In some embodiments, the random terpolymer of polypropylene may be derived from monomers of propylene (C3), ethylene (C2), and butylene (C4). In at least some embodiments, the ethylene (C2) may be present in an amount ranging from 0.1% to 10% by weight based on the total weight of the terpolymer of polypropylene. In some embodiments, the ethylene (C2) may be present in an amount ranging from 0.1% to 5% by weight of the terpolymer of polypropylene. And, in other embodiments, the ethylene (C2) may be present in an amount ranging from 1% to 5% by weight of the terpolymer of polypropylene. In at least one embodiment, the ethylene (C2) may be about 1% to about 2% by weight of the terpolymer of polypropylene. In another embodiment, the ethylene (C2) may be 4.75%. In another embodiment, butylene (C4) may be present in an amount ranging from 0.01% to 10% by weight of terpolymer of polypropylene. In at least one embodiment, butylene (C4) may be about 1% to about 7% by weight of the terpolymer of polypropylene. In another embodiment, butylene (C4) may be 1% by weight of the terpolymer of polypropylene. In another embodiment, butylene (C4) may be about 6% to about 7% by weight of the terpolymer of polypropylene.

In at least some embodiments, the polypropylene-based composition comprising the random terpolymer of polypropylene comprises at least one β nucleating agent. In some embodiments, the β nucleating agent may be chosen from NAB-82 and NU-100. In at least one embodiment, the β nucleating agent is NAB-82. In at least one embodiment, the addition of NAB-82 reduces the melting point of the resin while maintain the stiffness of the micro-pellet (non-foamed). In another embodiment, NAB-82 can maintain its function in a wide temperature range.

In some embodiments, the at least one β nucleating agent may be present in an amount ranging from 0.01% to 2% by weight of the polypropylene-based composition comprising the random terpolymer of polypropylene, but in an amount more than any α nucleating agent, if present. In at least one embodiment, at least one β nucleating agent may be present in an amount ranging from 0.1% to 1.0% by weight of the polypropylene-based composition, but in an amount more than any α nucleating agent, if present. In one embodiment, the at least one β nucleating agent may be present in an amount of about 0.1% by weight of the polypropylene-based composition comprising the random terpolymer of polypropylene, but in an amount more than any α nucleating agent, if present.

In at least some embodiments, the polypropylene-based composition comprising the random terpolymer of polypropylene may further comprise one or more α nucleating agents. In some embodiments, the α nucleating agent may be chosen from NA-11 and NX-8000. In at least one embodiment, the α nucleating agent is NX-8000. In some embodiments, the one or more α nucleating agents may be present in an amount ranging from 0.01% to 0.99% by weight of the polypropylene-based composition. In at least one embodiment, the one or more α nucleating agents may be present in an amount ranging from 0.1% to 0.99% by weight of the polypropylene-based composition. In at least some embodiments, the polypropylene-based composition comprising the random terpolymer of polypropylene does not contain an α nucleating agent.

In some embodiments, the polypropylene-based composition can be foamed at a lower temperature range than foams prepared from High Melt Strength Polypropylene (HMS-PP). For example, the temperature range may be reduced from 150-160° C. to 130-145° C. In some embodiments, the stiffness of the final foamed, molded product is better than the stiffness of foamed, molded products made with, for example, WB140 which is a high melt strength polypropylene from Borealis.

In some embodiments, the polypropylene-based composition comprising the random terpolymer of polypropylene has two melting points (i.e., two melting peaks as measured by DSC with a scan range from 30 □° C. to 190 □° C. at a rate of 10 □° C./min). In at least one embodiment, the two melting points are (i) chosen from a low melting point (Tm-low) of no less than 110° C. and (ii) a high melting point (Tm-high) of no more than 142° C. In some embodiments, the low melting point (Tm-low) may be in the range of 110° C. to 129° C. In one embodiment, the low melting point (Tm-low) is 121° C. In another embodiment, the low melting point (Tm-low) is 129° C. In some embodiments, the high melting point (Tm-high) may be in the range of 135° C. to 142° C. In some embodiments, the high melting point (Tm-high) is 138° C. In another embodiment, the high melting point (Tm-high) is 142° C.

In other embodiments, the polypropylene-based composition comprising the random terpolymer of polypropylene may further comprise one or more additives. In some embodiments, the one or more additives may be chosen from impact modifiers, polar modifiers, slip agents, anti-oxidants, and anti-acid agents. In at least some embodiments, a suitable impact modifier is chosen from Engage 8150 and Engage 8401. In another embodiment, a suitable polar modifier is chosen from Evaloy AC3427 and Lotryl 29MA03. In some other embodiments, a suitable slip agent is chosen from MB50-001 and MB50-321. In some embodiments, a suitable anti-oxidant agent is chosen from Irganox 1010 and Irgafos 168. In one embodiment, a suitable anti-acid agent is CaSt.

Micro-Pellet Made from the Polypropylene-Based Compositions

In at least some embodiments, a micro-pellet (non-foamed) is formed from the polypropylene-based compositions disclosed above by an extrusion process. In some embodiments, the micro-pellet has a size in a range of about 0.2 mm to about 2 mm. In at least some embodiments, the micro-pellet size may be, for example, about 0.2 mm, about 0.3 mm, about 0.4 mm, about 0.5 mm, about 0.6 mm, about 0.7 mm, about 0.8 mm, about 0.9 mm, about 1 mm, about 1.2 mm, about 1.4 mm, about 1.6 mm, about 1.8 mm, and about 2 mm.

Method for Manufacturing Polypropylene Foam

In some embodiments, the polypropylene-based compositions of the present disclosure may be used in an improved method for manufacturing polypropylene molded foam comprising:

a) extruding the polypropylene-based composition to form a polypropylene micro-pellet;

b) foaming the polypropylene micro-pellet; and

c) directly molding the polypropylene micro-pellet in a molding machine;
wherein the foaming pressure is in a range from 144 psi to 2050 psi, the foaming temperature is between the two melting points, as reflected by two peaks on a DSC trace, of the polypropylene-based composition, and the foaming time is at least 5 minutes but not more than 30 minutes.

In some embodiments, the improved method for manufacturing final foamed, molded products directly molds the polypropylene micro-pellet (non-foamed) in a batch physical foaming machine, such as an autoclave, without performing the steps of (i) conveying the micro-pellets to the autoclave for batch foaming by mixing in a liquid medium and then injecting a gas into the autoclave for micro-pellet impregnation and (ii) after the micro-pellets are well-foamed with the gas, depressurizing the autoclave system to make EPP foam beads, and further drying the EPP foam beads before packaging. Thus, the improved method does not require the steps of mixing in a liquid medium and steaming that are typical in a standard EPP foam beads procedure because the micro-pellets can be directly conveyed to the molding machine. That is, the polypropylene micro-pellets can just be heated to foam and bond together and do not need the use of steam of step 4 to heat and fusion-bond to form the final foamed, molded products.

In at least some embodiments, the final foamed, molded products produced by the above method have the following characteristics:

a. a foam density of less than 0.2 g/cm³;

b. an optimal expansion ratio between 10 and 20;

c. good mechanical properties chosen from thickness, density, shrinkage, tensile strength, elongation at break, tear strength, open cell ratio, and bonding strength; and

d. a stiffness of no less than 9000 kg/cm².

While the polypropylene-based compositions of the present disclosure may be used in the improved method for manufacturing polypropylene foam, it is contemplated that the polypropylene-based compositions of the present disclosure may also be used to form EPP foam beads, which may be later formed into final foamed, molded products.

The accompanying drawings, which are incorporated in and constitute a part of this specification, illustrate exemplary embodiments of the disclosure and together with the description, serve to explain the principles of certain embodiments.

### BRIEF DESCRIPTION OF THE DRAWINGS

FIG. 1A shows a conventional method for manufacturing a polypropylene foam; and FIG. 1B shows the Pellet Direct Foaming (PDF) method of the present disclosure.

FIG. 2 shows a non-limiting, exemplary system for making a polypropylene foam with a batch process.

FIG. 3 shows photos depicting the appearance of formulations as made according to Example 1.

FIG. 4 shows an SEM image of a polypropylene foam made according to an exemplary batch process of Example 3-1.

FIG. 5 shows an SEM image of a polypropylene foam made according to an exemplary batch process disclosed in Example 3-2.

FIG. 6 shows an SEM image of a polypropylene foam made according to an exemplary batch process disclosed in Example 3-3.

FIG. 7 shows an SEM image of a polypropylene foam made according to an exemplary batch process disclosed in Example 3-4.

FIG. 8 is a Differential Scanning calorimetry (“DSC”) trace of a polypropylene foam made according to Comparative Example 5-3.

FIG. 9 is a DSC trace of a polypropylene foam made according to Example 5-1.

FIG. 10 is a DSC trace of a polypropylene foam made according to Example 5-2.

FIG. 11 is a DSC trace of a polypropylene foam made according to Example 5-3.

FIG. 12 is a DSC trace of a polypropylene foam made according to Example 5-5.

FIG. 13 is a DSC trace of a polypropylene foam made according to Example 5-6.

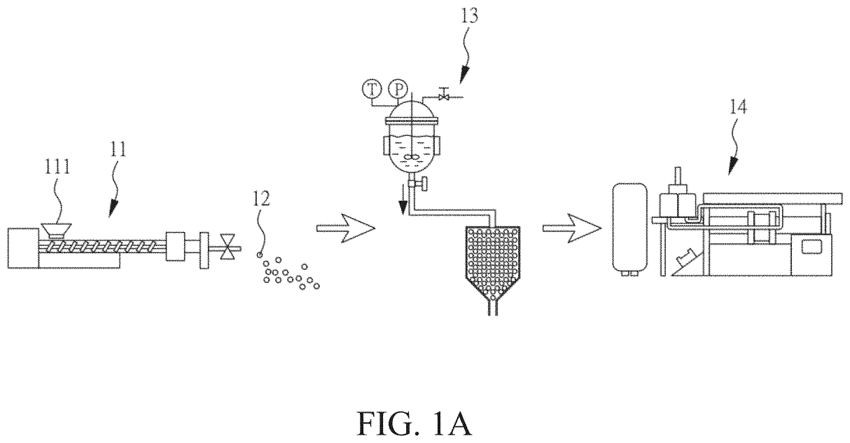

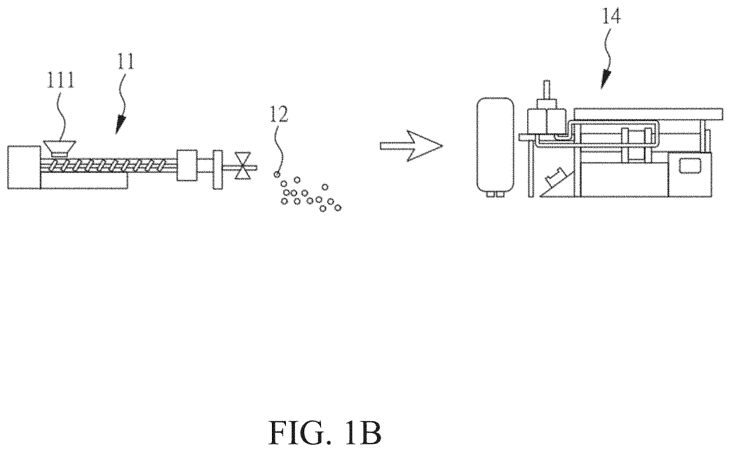

### DETAILED DESCRIPTION OF THE PREFERRED EMBODIMENT

The present disclosure provides improved polypropylene-based compositions (formulations), improved micro-pellets (non-foamed) made from the improved polypropylene-based compositions, and a new method of manufacturing final foamed, molded products, i.e., foamed molded products of expanded polypropylene beads, by extruding the improved polypropylene-based composition to form polypropylene micro-pellets, and directly molding the polypropylene micro-pellets in a batch physical foaming machine. The improved polypropylene-based compositions comprise either a random copolymer or random terpolymer of polypropylene and have at least one β nucleating agent. The improved polypropylene-based compositions have a better stiffness than the commercial HMSPP at similar foaming density range. It was also found that the micro-pellets' fusion capability was better when the final foamed micro-pellets were bigger (a higher extrusion output rate results in a bigger pellet). The disclosed micro-pellets can be foamed at a lower temperature range than, for example, PP flakes (e.g., Globalene® PC366-3 (“PC366-3,” homopolymer of propylene from LCY Chemical Corp.), 7633U (“7633U”—Heterophasic PP copolymer from LCY Chemical Corp.) and 1120 (“1120”—Homopolymer PP from Formosa), and the stiffness of the foams prepared is also better than that of the commercial HMSPP. It was further found that improved polypropylene compositions can be obtained by using different formulations (e.g., random copolymer of polypropylene+modifier (e.g., TPE, POE), other polymers) compared to the unmodified polypropylene resins, and that these improved compositions have a lower foaming pressure (e.g., 1025 psi) and foaming time (e.g., 5 min). Moreover, the modified polypropylene results in compositions with two melting points, as reflected by two peaks on a DSC trace, when the C2 and/or C4 content of the random copolymer of polypropylene or the random terpolymer of polypropylene are adjusted, but the modified polypropylene composition must also include at least one β nucleating agent, and optionally one or more α nucleating agents. For example, it was further found, that a low Tin can be kept by further adjusting the C2 and C4 content of a random terpolymer of polypropylene and the proportion of α and β nucleating agents. Surprisingly, it was found that despite the low Tin, the mechanical strength still increases (e.g., tensile strength, tear strength and elongation @ break) of the final foamed, molded products when compared to those of existing commercial grades, Globalene® ST866 ((“ST866”—a random copolymer of polypropylene from LCY Chemical Corp.) and cosmoplene FL7540L (“FL7540L”—a random terpolymer of polypropylene from TPC) at a similar density range. In addition, it was found that the addition of an α nucleating agent can be beneficial to increase stiffness in compositions containing random copolymer of polypropylene with the same C2 content (e.g., C2 content is 2˜4%).

In some embodiments, the polypropylene-based composition comprises a random copolymer of polypropylene, at least one β nucleating agent, and one or more α nucleating agents. In some embodiments, the polypropylene-based composition comprises a higher weight ratio of β to α nucleating agents; in some cases, at least a 4:1 ratio may be needed of β to α nucleating agents to achieve two melting points, but a 2:1 ratio of β to α nucleating agents may still achieve two melting points depending on the α nucleating agent used. In some embodiments, the random copolymer of polypropylene is derived from monomers of propylene (C3), and one of ethylene (C2) and butylene (C4). In at least one embodiment, the amount of ethylene (C2) may be in a range from 0.01 weight % to 10 weight % based on a total weight of the random copolymer of polypropylene, and optionally butylene (C4) in a range from 0.01 weight % to 10 weight % based on a total weight of the random copolymer of polypropylene.

In some embodiments, the polypropylene-based composition comprises a random terpolymer of polypropylene, at least one β nucleating agent and optionally one or more α nucleating agents. In at least some embodiments, the combined mass of the β nucleating agents is greater than the mass of the one or more α nucleating agents (e.g., weight ratios of 2:1; 3:1; 4:1, etc.). In some embodiments, the ethylene (C2) and butylene (C4) content of random terpolymer polypropylene is adjusted to improve the modulus of the random terpolymer of polypropylene. In some embodiments, increasing the ethylene (C2) and butylene (C4) content increases the modulus. However, increasing the butylene (C4) content may increase stiffness and increasing the ethylene (C2) content may lower Tin. Accordingly, a balancing of properties may require adjust of both the ethylene (C2) and butylene (C4) content. Furthermore, a balancing of properties may also require adjustment of the amount and types of nucleating agents.

According to certain embodiments, the polypropylene-based composition disclosed comprises a random copolymer of polypropylene derived from monomers of propylene (C3), and one of ethylene (C2) and butylene (C4), and at least one β nucleating agent. In some embodiments, the random copolymer of polypropylene may be present in an amount of at least 90% by weight, for example in an amount ranging from 90% to 99.99% by weight or 95.98% by weight of the polypropylene-based composition. In some embodiments, the random copolymer of polypropylene may be present in an amount ranging from 95.98% to 99.97% by weight of the polypropylene-based composition. In some embodiments, the random copolymer of polypropylene may be present in an amount ranging from 97.01% to 99.98% by weight of the polypropylene-based composition. In some embodiments, the random copolymer of polypropylene may be present in an amount ranging from 98% to 99.99% by weight of the polypropylene-based composition. In some embodiments, the random copolymer of polypropylene may be present in an amount ranging from 99.0% to 99.4% by weight of the polypropylene-based composition. In at least one embodiment, the random copolymer of polypropylene may be present in an amount ranging from 99.5% to 99.9% by weight of the polypropylene-based composition.

In some embodiments, the polypropylene-based composition of the present disclosure comprises a random copolymer of polypropylene derived from monomers of propylene (C3), and one of ethylene (C2) and butylene (C4); and at least one β nucleating agent. In some embodiments, a melt flow rate of the random copolymer of polypropylene may be in a ranged from 5 g/10 min to 10 g/10 min., for example, from 6 g/10 min to 10 g/10 min, from 7 g/10 min to 10 g/10 min, from 8 g/10 min to 10 g/10 min, from 5 g/10 min to 9 g/10 min, from 6 g/10 min to 9 g/10 min, from 7 g/10 min to 9 g/10 min or from 8 g/10 min to 9 g/10 min. In at least one embodiment, the melt flow rate of the random copolymer of polypropylene is 5 g/10 min. In another embodiment, the melt flow rate of the random copolymer of polypropylene is 8 g/10 min.

In at least some embodiments, ethylene (C2) may be present in the polypropylene-based composition of the present disclosure in an amount ranging from 0.01 to 10% by weight based on a total weight of the random copolymer of polypropylene. In some embodiments, butylene (C4) may be present in the polypropylene-based composition of the present disclosure in an amount ranging from 0.01 to 10% by weight based on a total weight of the random copolymer of polypropylene. In some embodiments, the C2 content may be chosen from 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, and 4% by weight based on a total weight of the random copolymer of polypropylene. In one embodiment, the C2 content may be chosen from 1%, 2%, 3%, and 4% by weight based on a total weight of the random copolymer of ethylene and propylene. In some embodiments, the C4 content may be chosen from 1%, 2%, 3%, 4%, 5%, 6%, 7%, 8%, and 9% by weight based on a total weight of the random copolymer of polypropylene.

In at least some embodiments, the polypropylene-based composition disclosed has two melting points as reflected by two melting peaks in a DSC trace. In some embodiments, the low melting point (Tm-low) is no less than 130° C. and the high melting point (Tm-high) is not more than 160° C. In some embodiments, the low melting point (Tm-low) is no less than 135° C. and the high melting point (Tm-high) is not more than 165° C. In at least one embodiment, the low melting point (Tm-low) is 134° C. and the high melting point (Tm-high) is 153° C.

According to certain embodiments, the polypropylene-based composition disclosed comprises a random terpolymer of polypropylene derived from monomers of propylene (C3), ethylene (C2), and butylene (C4), and at least one β nucleating agent. In at least some embodiments, the random terpolymer of polypropylene may be present in an amount of at least 90% by weight, for example, in an amount ranging from 90% to 99.99% by weight or 94% by weight of the polypropylene-based composition. In some embodiments, the random terpolymer of polypropylene may be present in an amount ranging from 94% to 99.97% by weight of the polypropylene-based composition. In some embodiments, the random terpolymer of polypropylene may be present in an amount ranging from 95.98% to 99.97% by weight of the polypropylene-based composition. In some embodiments, the random terpolymer of polypropylene may be present in an amount ranging from 96% to 99.98% by weight of the polypropylene-based composition. In some embodiments, the random terpolymer of polypropylene may be present in an amount ranging from 97.0% to 99.98% by weight of the polypropylene-based composition. In at least one embodiment, the random terpolymer of polypropylene may be present in an amount ranging from 98.0% to 99.98% by weight of the polypropylene-based composition. In another embodiment, the random terpolymer of polypropylene may be present in an amount ranging from 99.0% to 99.98% by weight of the polypropylene-based composition.

The α and β nucleating agents may be organic or inorganic substances. When added, the nucleating agents may provide one or more functions such as increasing the crystallization rate, providing a higher degree of crystallinity, resulting in a more uniform crystalline structure, and/or improving mechanical properties.

In some embodiments, only a β nucleating agent is present in the polypropylene-based composition. In some embodiments, the addition of only a β nucleating agent still induces two melting peaks, as reflected on a DSC trace.

In some embodiments, the at least one β nucleating agent may be present in an amount ranging from 0.01 to 2% by weight of the polypropylene-based composition. In some embodiments, the at least one β nucleating agent may be present in an amount ranging from 0.01 to 1.8% by weight of the polypropylene-based composition, for example, 0.02 to 0.04% by weight, 0.06 to 0.08% by weight, 0.1 to 1.2% by weight, or 1.4 to 1.6% by weight. In some embodiments, the at least one β nucleating agent is present in an amount chosen from 0.1%, 0.2%, 0.3%, 0.4%, 0.5%, 0.6%, 0.7%, 0.8%, or 0.9% by weight of the polypropylene based composition.

In some embodiments, the polypropylene-based composition further comprises one or more α nucleating agents. In some embodiments, the one or more α nucleating agents may be present in an amount ranging from 0.01 to 0.99% by weight of the polypropylene-based composition, for example, 0.02 to 0.04% by weight, 0.05 to 0.07% by weight, 0.08 to 0.9% by weight. In some embodiments, the one or more α nucleating agents may be present in an amount chosen from 0.1%, 0.2%, 0.3%, 0.4%, 0.5%, 0.6%, 0.7%, 0.8%, or 0.9% by weight of the polypropylene-based composition.

In one embodiment, the addition of an α nucleating agent improves the stiffness of the subsequently obtained polypropylene foam compared to the base formulation, such as Globalene® ST611 without the α nucleating agent, at a similar density range. Globalene® ST611 (“ST611”) is a random copolymer of polypropylene from LCY Chemical Corp. In some embodiments, the amount of α nucleating agent (when present) to β nucleating agent is adjusted to keep the melting point Tin for the resin low and still increase the mechanical properties (e.g., tensile strength, tensile modulus, elongation at break) of the polypropylene molded foam. In another embodiment, the addition of both α and β nucleating agents produces two melting peaks, as reflected on a DSC trace, for the resin as long as the β nucleating agent is present in a higher amount than that of the α nucleating agent.

In some embodiments, the mass ratio of α and β nucleating agents is dependent on the types of α and β nucleating agents. For example, when NAB-82 (β nucleating agent) and NX8000 (an α nucleating agent) are used, suitable amounts of the nucleating agent may be 0.1% and 0.05% by weight, respectively, or 0.2% and 0.05% by weight, respectively, of the polypropylene-based composition. In at least some embodiments, the grade of polypropylene used determines the ratio for α and β nucleating agents needed to generate the two melting peaks. In some embodiments, the amount of the α and β nucleating agents should be as low as possible (e.g., 0.01% to 0.1%).

In at least some embodiments, each of ethylene (C2) and butylene (C4) may be present in the polypropylene-based composition in an amount ranging from 0.1 to 10% by weight based on a total weight of the random terpolymer of polypropylene. In some embodiments, the C2 content may be chosen from 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, and 4.75% by weight based on a total weight of the random terpolymer. In at least one embodiment, the C2 content may be chosen from 1%, 2%, and 4.75% by weight based on a total weight of the random terpolymer of polypropylene. In some embodiments, the C4 content may be chosen from 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%, 5.1%, 5.2%, 5.3%, 5.4%, 5.5%, 5.6%, 5.7%, 5.8%, 5.9%, 6%, 6.1%, 6.2%, 6.3%, 6.4%, 6.5%, 6.6%, 6.7%, 6.8%, 6.9%, and 7% by weight based on a total weight of the random terpolymer of polypropylene. In at least one embodiment, the C4 content may be chosen from 1%, 2%, 3%, 4%, 5%, 6%, and 7% by weight based on a total weight of the random terpolymer of polypropylene.

In at least some embodiments, the polypropylene-based composition comprising a random terpolymer of polypropylene has two melting points (as reflected by two melting peaks in a DSC trace). In some embodiments, the low melting point (Tm-low) may be no less than 110° C. and the high melting point (Tm-high) may be no more than 142° C. In some embodiments, the low melting point (Tm-low) may be no less than 120° C. and the high melting point (Tm-high) may be no more than 140° C. In at least one embodiment, the low melting point (Tm-low) is 121° C. and the high melting point (Tm-high) is 138° C. In another embodiment, the low melting point (Tm-low) is 129° C. and the high melting point (Tm-high) is 142° C.

In some embodiments, a micro-pellet (non-foamed) is formed from the polypropylene-based composition by an extrusion process. In at least some embodiments, the micro-pellet size is proportional to the extrusion output rate. In some embodiments, the micro-pellet size may be in a range from about 0.2 mm to about 2 mm. In another embodiment, the extrusion output rate may be chosen from 20 kg/hr, 30 kg/hr, or 45 kg/hr.

MFR (melt flow rate) is an indirect measure of molecular weight, with a high MFR corresponding to a low molecular weight. The test conditions for measuring MFR can be found in ASTM D1238, which provides that the standard conditions for measuring the MFR of polypropylene compositions is under a load of 2.16 kg and at 230° C.

In at least one embodiment, the composition has an Izod impact strength, as measured according to ASTM D256 (at 23° C., notched), of no less than 8 kg-cm/cm. For example, in some embodiments, the composition has an Izod impact strength ranging from 4.5 to 50 kg-cm/cm, such as from 4.5 kg-cm/cm to 40 kg-cm/cm, 4.5 kg-cm/cm to 24 kg-cm/cm, 4.5 kg-cm/cm to 11 kg-cm/cm, or 4.5 kg-cm/cm to 10 kg-cm/cm.

In some embodiments, the polypropylene is chosen from random copolymers of polypropylene derived from monomers of propylene (C3) and one of ethylene (C2) or butylene (C4). In at least some embodiments, the ethylene (C2) may be 0.01 wt % to 10 wt % based on a total weight of the random copolymer of polypropylene of ethylene and propylene. In at least one embodiment, the ethylene (C2) may be 2 wt % to 4 wt % based on a total weight of the random copolymer of ethylene and propylene. And, in some embodiments, butylene (C4) may be 0.01 wt % to 10 wt % based on a total weight of the random copolymer of polypropylene of butylene and propylene. In at least one embodiment, the butylene (C4) may be 4 wt % to 8 wt % based on a total weight of the random copolymer of butylene and propylene.

In some embodiments, the random copolymer of polypropylene may have a weight average molecular weight ranging from 300,000 to 420,000. As non-limiting examples of a random copolymer of polypropylene: Globalene® 8181, 6181, ST611, ST611K, ST611M, ST925, ST866, ST861, ST866M, ST861K, ST868M, ST868K, or 8681 supplied by LCY Chemical Corp.

In some embodiments, the polypropylene is chosen from random terpolymers of polypropylene derived from monomers of propylene(C3), ethylene (C2), and butylene (C4). In at least some embodiments, the ethylene (C2) may be 0.1 wt % to 10 wt % based on a total weight of the random terpolymer of polypropylene. In one embodiment, the ethylene (C2) may be 1 wt % to 5 wt % based on a total weight of the random terpolymer of polypropylene. And, in some embodiments, butylene (C4) may be 0.1 wt % to 10 wt % based on a total weight of the random terpolymer of polypropylene. In at least one embodiment, butylene (C4) is 1 wt % to 6 wt % based on a total weight of the random terpolymer of polypropylene.

In some embodiments, the random terpolymer of polypropylene may be chosen from a random terpolymer of polypropylene: Cosmoplene FL7540L (a random terpolymer of polypropylene e from TPC), YCC 5050 (a random terpolymer of polypropylene from Formosa), and EP3C37F (a random terpolymer of polypropylene from LCY Chemical Corp).

In at least some embodiments, the one or more α nucleating agents may be chosen from organic α nucleating agents such as sorbitol derivatives including, but not limited to, 1,2,3,4-bis-dibenzylidene sorbitol (DBS), 1,2,3,4-bis-(p-methoxybenzylidene sorbitol) (DOS), 1,2,3,4-bis-(3,4-dimethylbenzylidene sorbitol) (MDBS), 1,3:2,4-di(3,4-dimethylbenzylidene) sorbitol (DMDBS), and bis(4-propylbenzylidene) propyl sorbitol. In at least some embodiments, the one or more α nucleating agents may be chosen from organic α nucleating agents such as monovalent, bivalent, and trivalent 2,2′-methylene-bis-(4,6-di-tertbutylphenyl) phosphate metal salts (e.g., sodium 2,2′-methylene-bis-(4,6-di-t-butylphenylene) phosphate, known commercially as NA-11, bivalent calcium salt (NA-20), magnesium salt (NA-12), zinc salt (NA-30), and trivalent aluminum salt (NA-13)); sodium benzoate; lithium benzoate; 1,2-cyclohexanedicarboxylic acid (e.g., Hyperform® HPN-20E from Milliken & Company, which is a calcium salt of 1,2-cyclohexanedicarboxylic acid).

In some embodiments, the one or more α nucleating agents may be chosen from inorganic α nucleating agents, such as calcium salts, talc, silica, mica, kaolin, diatomite, and wollastonite.

In some embodiments, the one or more α nucleating agents may be present in an amount ranging from 0.01% to 0.99% by weight, relative to the total weight of the polypropylene-based composition. In one embodiment, the one or more α nucleating agents may be present in an amount ranging from 0.02% to 0.9% by weight, such as from 0.05% to 0.8%, from 0.07% to 0.6%, or from 0.08% to 0.4% by weight, relative to the total weight of the polypropylene-based composition.

In at least some embodiments, the at least one β nucleating agent may be chosen from: aluminum salts of 6-quinazirin sulfonic acid, phthalic acid disodium salt, isophthalic acid, terephthalic acid, N—N′-dicyclohexyl-2,6-naphthalene dicarboximide (such as known under the trade name NJ Star NU-100), a mixture of a dibasic acid with an oxide, hydroxide, or acid salt of a Group II metal. Examples of suitable dibasic acids are pimelic acid, azelaic acid, o-phtalic acid, terephthalic acid and isophthalic acid and the like. Suitable oxide, hydroxides or acid salts of Group II metals are compounds comprising magnesium, calcium, strontium or barium, with typical examples including calcium carbonate or other carbonates.

In at least some embodiments, the at least one β nucleating agent may be chosen from (i) quinacridone type compounds, such as quinacridone, dimethylquinacridone, and dimethoxyquinacridone, (ii) quinacridonequinone type compounds, such as quinacridonequinone, a mixed crystal of 5,12-dihydro(2,3b)acridine-7,14-dione with quino(2,3b)acridine-6,7,13,14-(5H,12H)-tetrone as disclosed in EP 0 177 961 and dimethoxyquinacridonequinone; and (iii) dihydroquinacridone type compounds, such as dihydroquinacridone, di-methoxydihydroquinacridone, and dibenzodihydroquinacridone.

In other embodiments, the at least one β nucleating agent may be chosen from dicarboxylic acid salts of metals from Group IIa of periodic table, such as pimelic acid calcium salt, and suberic acid calcium salt.

In at least some embodiments, the at least one β nucleating agent may be present in an amount ranging from 0.01% to 2% by weight, relative to the total weight of the polypropylene-based composition. In some embodiments, the at least one β nucleating agent may be present, for example, in an amount ranging from 0.1% to 2%, such as from 0.3% to 1.5%, 0.6% to 1.2%, or 0.8% to 1% by weight, relative to the total weight of the polypropylene-based composition.

In some embodiments, the weight ratio of the β nucleating agent (or agents) to the α nucleating agent (or agents) may range from 20:1 to 2:1. As non-limiting examples, the weight ratio of the β nucleating agent (or agents) to the α nucleating agent (or agents) may range from 2:1 to 10:1; such as from 3:1 to 8:1, from 4:1 to 6:1, or from 4:1 to 5:1. In some embodiments, the weight ratio of the β nucleating agent (or agents) to the α nucleating agent (or agents) ranges from 1:1 to 10:1, from 1:1 to 5:1, or from 1:1 to 3:1. As non-limiting examples, the weight ratio of the β nucleating agent (or agents) to the α nucleating agent (or agents) is chosen from 2:1, 3:1, 4:1, 5:1, 6:1, 7:1, 8:1, 9:1, and 10:1.

In some embodiments, the weight ratio of the β nucleating agent (or agents) to the α nucleating agent (or agents) may vary based on the specific combination of α and β nucleating agents present in the polypropylene-based composition. For example, an α nucleating agent, such as NA11, may have a strong efficiency to form α crystals and may inhibit the generation of β crystals even if the amount of β nucleating agent, such as NAB-82, is twice the amount of the α nucleating agent. Thus, in some embodiments, the weight ratio of the β nucleating agent (or agents) to the α nucleating agent (or agents) may range from 4:1 to 10:1; such as from 4:1 to 8:1, from 4:1 to 6:1. In one embodiment, the weight ratio of the β nucleating agent (or agents) to the α nucleating agent (or agents) is 4:1.

In at least some embodiments, the polypropylene-based composition may further comprise one or more additives chosen from, as non-limiting examples, blowing agents, fillers, flame retardants, anti-static agents, UV-stabilizers, cell stabilizers, thermostabilizers, anti-dripping agents, colorants, pigments, dyes, acid reducing agents, lubricants, antioxidants, antibacterial agents, impact modifiers, and processing aids. Suitable fillers may include but are not limited to carbon nanotubes, glass fibers, calcium carbonate, and carbon black. As a non-limiting example, the one or more additives may be present in an amount ranging from 0.0001% to 4%, such as from 0.01% to 2% or 0.1% to 1% by weight, relative to the total weight of the polypropylene-based composition.

In at least some embodiments, the polypropylene-based composition for preparing polypropylene foam may further comprise one or more polyolefin elastomers, and/or one or more thermoplastic elastomers. In some embodiments, the composition for preparing polypropylene foam may further comprise one or more thermoplastic vulcanizates.

In at least some embodiments, suitable blowing agents include non-hydrocarbon blowing agents, organic blowing agents, chemical blowing agents, and combinations thereof. Possible combinations of blowing agents include, for example, a non-hydrocarbon and a chemical blowing agent, or an organic blowing agent and a chemical blowing agent, or a non-hydrocarbon blowing agent, an organic blowing agent, and a chemical blowing agent.

In some embodiments, suitable non-hydrocarbon blowing agents may include but are not limited to carbon dioxide, nitrogen, argon, water, air, nitrous oxide, helium, and combinations thereof. In some embodiments, the non-hydrocarbon blowing agent may be carbon dioxide gas.

In some embodiments, suitable organic blowing agents may include but are not limited to: aliphatic hydrocarbons having 1-9 carbon atoms, aliphatic alcohols having 1-3 carbon atoms, aliphatic ketones having 1-3 carbon atoms, aliphatic esters having 1-3 carbon atoms, aliphatic ethers having 1-4 carbon atoms, fully and partially halogenated aliphatic hydrocarbons having 1-4 carbon atoms, and combinations thereof. As non-limiting examples, suitable aliphatic hydrocarbons may include methane, ethane, propane, n-butane, isobutane, n-pentane, isopentane, cyclopentane, neopentane, and petroleum ether. Also, as non-limiting examples, suitable aliphatic alcohols may include methanol, ethanol, n-propanol, and isopropanol. Further as non-limiting examples, suitable aliphatic ketones may include acetone; aliphatic esters such as methyl formate; aliphatic ethers such as diethyl ether and dimethyl ether; fully and partially halogenated aliphatic hydrocarbons such as fluorocarbons, chlorocarbons, and chlorofluorocarbons; chlorofluorocarbons and fluorocarbons such as 1,1,1,4,4,4-hexafluoro-2-butylene, 1,1-dichloro-1-fluoro-ethane, 2,2-dichloro-1,1,1-trifluoroethane, 1-chloro-1,2-difluoro-ethane (HCFC-142a), 1-chloro-1,1-difluoroethane (HCFC-142b), 1,1,1,2-tetrafluoroethane (hydrofluorocarbon (HFC)-134a or R134A), 1,1,1,3,3-pentafluoropropane, 1,1,1,3,3-pentafluorobutane, 2-chloropropane, dichlorodifluoromethane (CFC-12), 1,2-dichloro-1,1,2,2-tetrafluoroethane, 1-chloro-1,2-difluoro-ethane, trichlorotrifluoroethane and/or trichloromono-fluoromethane (CFC-11), as well as mixtures of 1-chloro-1,2-difluoroethane (HCFC-142a) and 1-chloro-1,1-difluoroethane (HCFC-142b), 1,3,3,3-tetrafluoropropene (HFO-1234ze), 1,1-difluoroethane (HFC-152a), 1,1,1,2-tetrafluorethane (HFC-134a) and chlorodifluoromethane (R22). In at least one embodiment, the organic blowing agent may be R134A.

In some embodiments, suitable organic blowing agents may include n-butane, iso-butane, ethanol, isopropanol, dimethyl ether, and mixtures thereof.

In some embodiments, suitable chemical blowing agents may include but are not limited to azocarbonate-based and hydrazide-based compounds, such as azodicarbonamide, azodiisobutyronitrile, benzenesulphonyl hydrazide, 4,4′-oxy-bis-(benzenesulfonyl semicarbazide), organic acids and their derivatives, alkali metal carbonates, alkali metal bicarbonates, and mixtures thereof.

As non-limiting examples of organic acids and acid derivatives that may be suitable as chemical blowing agents include oxalic acid and oxalic acid derivatives, succinic acid and succinic acid derivatives, adipic acid and adipic acid derivatives, phthalic acid and phthalic acid derivatives, and citric acid, citric acid salts, and citric acid esters. Further as non-limiting examples, citric acid esters include those of higher alcohols, such as stearyl or lauryl citrate, and both mono- and diesters of citric acid with lower alcohols having 1-8 carbon atoms. Suitable lower alcohols from which these citric acid esters can be formed are, for example: methanol, ethanol, propanol, isopropanol, n-butanol, iso-butanol, sec-butanol, tert-butanol, n-pentanol, n-pentan-2-ol, n-pentan-3-ol, n-hexan-3-ol and isomeric hexanols, n-heptan-1-ol, n-heptan-2-ol, n-heptan-3-ol, n-heptan-4-ol and isomeric heptanols, n-octan-1-ol, n-octan-2-ol, n-octan-3-ol, n-octan-4-ol and isomeric octanols, cyclopentanol, and cyclohexanol. Additional suitable lower alcohols include diols or polyols with 1-8 carbon atoms, such as ethylene glycol, glycerol, and pentaerythritol; lower polyethylene glycols, such as diethylene glycol, triethylene glycol, and tetraethylene glycol; mono- or diesters with monohydric alcohols having 1-6 carbon atoms, such as monomethyl citrate, monoethyl citrate, monopropyl citrate, monoisopropyl citrate, mono-n-butyl citrate, and mono-tert-butyl citrate.

Further non-limiting examples of chemical blowing agents include alkali or earth alkali metal carbonates and bicarbonates, such as calcium carbonate, magnesium carbonate, calcium bicarbonate, magnesium bicarbonate, ammonium bicarbonate, sodium carbonate, potassium carbonates.

In some embodiments, the at least one blowing agent may be chosen from CO₂ gas and R134A.

In some embodiments, the blowing agent may be present in an amount ranging from 0% to 10%, such as 0.1% to 5% or 0.5% to 4% by weight, relative to the total weight of the composition.

Methods of Preparation

The present disclosure provides an improved method of preparing polypropylene foam. In at least one embodiment, the method for manufacturing polypropylene molded foam as a final foamed, molded product comprises:

(a) extruding a polypropylene-based composition to form polypropylene micro-pellets (non-foamed); and

(b) foaming the non-foamed micro-pellet in a molding machine at a foaming pressure, a foaming temperature and a foaming time, wherein the foaming pressure ranges from 144 psi to 2050 psi, the foaming temperature is between the low melting point (Tm-low) and the high melting point (Tm-high) of the polypropylene-based composition (as reflecting by two melting peaks on a DSC trace), and the foaming time ranges from 5 minutes to 30 minutes.

In some embodiments, the foaming pressure is greater than 2000 psi to achieve a low foam density in a range of, for example, 0.02 to 0.2 g/cm³. Then the foaming pressure is less than 2000 psi (for example, less than 1025 psi) or in a range from 144 psi to 1025 psi, from 400 psi to 1025 psi or from 700 psi to 1025 psi. In addition, foam densities greater than 0.8 g/cc have been observed. In one embodiment, the foam pressure may be chosen from 2000 psi, 2050 psi, 2250 psi, and 2500 psi. In another embodiment, the foaming time is higher than 10 minutes to achieve a low foam density. In at least some embodiments, the foaming time is chosen from 10 minutes, 15 minutes, 20 minutes, 25 minutes, and 30 minutes.

In at least one embodiment, the method for manufacturing polypropylene molded foam as a final foamed, molded product does not require the mixing of the micro-pellet in a liquid medium step or the steaming of EPP foam beads step before the steps of foaming and molding in the molding machine. In at least one embodiment, the method for manufacturing the polypropylene molded foam comprises extruding the polypropylene-based composition to form polypropylene micro-pellets (non-foamed), and directly molding the polypropylene micro-pellets in a batch physical foaming machine. In some embodiments, the method for manufacturing the polypropylene molded foam is performed under a lower foaming pressure, a lower foaming temperature, and a lower foaming time as compared to the unmodified polypropylene-based compositions comprising random copolymer of polypropylene (e.g., ST866) or unmodified random terpolymer of polypropylene (e.g., FL7540L), wherein the temperature is between the two melting points, as reflected by two peaks on a DSC trace (i.e., ranging between the two melting points of the polypropylene-based composition).

In at least one embodiment, the polypropylene molded foam as a final foamed, molded product produced by the above method may have a foam density of less than 0.2 g/cm³. In one embodiment, the foam density may be less than 0.1 g/cm³. In another embodiment, the polypropylene foam may have an optimal expansion ratio of 10˜20. The expansion ratio refers to the ratio of the density of unfoamed polymer composition to the density of the foam sample. In at least one embodiment, the resulting polypropylene molded foam may have good mechanical properties with respect to thickness, density, shrinkage, tensile strength, elongation at break, tear strength, and bonding strength. In another embodiment, the polypropylene molded foam may have a stiffness of no less than 9000 kg/cm².

### EXAMPLES

The present disclosure may be better understood by reference to the following examples. These examples are intended for illustration purposes only and should not be construed as limiting the scope of the disclosure in any way. Further, the section headings used herein are for organizational purposes only and are not to be construed as limiting the subject matter described.

Analytical Methods

Foam Density

The mass densities of foamed polypropylene, including the final foamed, molded products, samples ρf were measured according to ASTM D792 involving weighing polymer foam in water using a sinker. ρf was calculated as follows:

$${ρ}_{f} = \frac{a}{a - b} {ρ}_{water}$$

wherein a is the apparent mass of sample in air, b is the apparent mass of the sample completely immersed in water, and ρwater is the density of water.

Scanning Electron Microscopy (SEM)

The morphologies of the obtained foamed polypropylene, including the final foamed, molded products, were studied by SEM (JEOL JSM-5600). The samples were immersed in liquid nitrogen for 30 min and then fractured. The fractured surfaces were sprayed with a layer of gold for further observation by SEM.

Differential Scanning calorimetry (DSC)

A TA Q100 DSC was used to characterize the melting behavior of the foamed polypropylene, including the final foamed, molded products. Samples weighing approximately 6-10 mg were used for DSC characterization. The scanning range was from 30° C. to 190° C. at a rate of 10° C./min.

Physical Properties Analysis of Foam

Tensile Strength and Elongation at Break (ISO 1798)

Prior to the test, the test pieces were cut and conditioned for at least 16 hours in 23±2° C., 50±5% relative humidity. Then, the machine was started at a jaw-separation rate of 500 mm/min and the maximum force and the distance were recorded between the inside edges of the two reference lines immediately prior to break of the test piece.

The tensile strength (TS) of each test piece, expressed in kilopascals (KPa), is given by the equation: TS=F/A*103,

wherein F is the maximum force, in newton (N); and A is the average initial cross-sectional area, in square millimeter (mm²)

The Elongation at break (Eb) expressed as a percentage of the original gauge length, is given by the equation: Eb=(L−L0)/L0*100, wherein L is the gauge length at break, in millimeter (mm); and L0 is the initial gauge length, in millimeter (mm)

Tear Strength (ISO 34-1)

Prior to the test, the test pieces were cut and conditioned for at least 3 hours in 23±2° C., 50±5% relative humidity. After conditioning, it was applied a steadily increasing traction force at a rate of separation of the grips of 500 mm/min for angle type test pieces and 100 mm/min for trouser test piece until the piece broke. Then, the maximum force was recorded for angle test piece.

The tear strength (TS) of each test piece, expressed in kilo-newton per meter (kN/m) of thickness, is given by the formula: TS=F/d,

wherein F is the maximum force, in newton; and d is the median thickness, in millimeter (mm), of the test piece.

Materials

WB140: High melt strength PP (HMS-PP) from Borealis.

Globalene® PC366-3 (“PC366-3,” MFR of 3 g/10 min): Polypropylene homopolymer from LCY Chemical Corp.

7633U—Heterophasic polypropylene copolymer from LCY Chemical Corp. C2 content is in a range from 7% to 9% by weight based on a total weight of the copolymer.

Globalene® ST866 (“ST866,” MFR of 8 g/10 min): Random copolymer of polypropylene from LCY Chemical Corp. C2 content is in a range from 2% to 4% by weight based on a total weight of the copolymer.

Globalene® ST611 (“ST611,” MFR of 1.8 g/10 min); Random copolymer of polypropylene from LCY Chemical Corp. C2 content is in a range from 2% to 4% by weight based on a total weight of the copolymer.

Cosmoplene FL7540L (“FL7540L”, MFR of 7.0 g/10 min): Random terpolymer of polypropylene from TPC.

YCC 5050 (“5050”, MFR of 5 g/10 min): Random terpolymer of polypropylene from Formosa.

NAB-82: Calcium tetrahydrophthalate (β nucleating agent) from GCHchem.

NU-100: N,N′-dicyclohexyl-2,6-naphtalene dicarboxamide (β nucleating agent) from New Japan Chemical Co., Ltd.

NA-11: 2,2′-methylene-bis-(4,6-di-tbutylphenylene) phosphate sodium salt (α nucleating agent) from Adeka.

NX8000: Bis(4-propylbenzylidene) propyl sorbitol (α nucleating agent) from Milliken & Company.

Engage 8150: Polyolefin elastomer of ethylene-octene copolymer (MFR 0.5) from Dow Chemical.

Evaloy AC 3427: Copolymer of ethylene and butyl acrylate (27% butyl acrylate content) from Du Pont.

MB50-001: Ultra-high molecular weight siloxane polymer, dispersed in polypropylene homopolymer (50% siloxane content) from Dow Corning.

MB50-321: Ultra-high molecular weight functionalized siloxane polymer dispersed in high flow polypropylene homopolymer (50% siloxane content) from Dow Corning.

1120: Polypropylene homopolymer from Formosa.

Engage 8401: Polyolefin elastomer of ethylene-octene copolymer (MFR 30) from Dow Chemical.

Lotryl 29MA03: Random copolymer of ethylene and methyl acrylate from Arkema.

8491: Random copolymer of polypropylene from LCY. C2 content is in a range from 2% to 4% by weight based on a total weight of the copolymer.

8492: Random copolymer of polypropylene from LCY. C2 content is in a range from 2% to 4% by weight based on a total weight of the copolymer.

ST8461: Random copolymer of polypropylene from LCY. C2 content is in a range from 2% to 4% by weight based on a total weight of the copolymer.

SEBS G1645M: Kraton G1645 M is a linear triblock copolymer based on styrene and ethylene/butylene from Kraton corporation.

ST612: Globalene® ST612 (“ST612”, MFR is 1.8 g/10 min): Random copolymer of polypropylene from LCY Chemical Corp. C2 content is in a range from 2% to 4% by weight based on a total weight of the copolymer.

ST925: Globalene® ST925 (“ST925”, MFR is 14 g/10 min): Random copolymer of polypropylene from LCY Chemical Corp. C4 content is in a range from 4% to 7% by weight based on a total weight of the copolymer.

CO₂ with a purity of 99.99% from Nippon Specialty Gas CO., LTD. (blowing agent).

HFC R134A with a purity of 99.9% from NINHUA GROUP CO., LTD (blowing agent).

General Procedure for Making the Test Specimens/Samples

The polypropylene resins and nucleating agent formulations of the examples were well-mixed in a high speed Henschel mixer for 30-60 seconds. The mixtures (10 kg each) were then put into the hopper of a co-rotating twin-screw extruder (L/D: 37, KM Berstorff ZE40A) with temperature setting 160-200° C. and screw rotational speed 260-300 rpm to obtain micro-pellet (non-foamed) samples, which were then put into the hopper of an injection molding machine (Chen Hsong Machinery, SM120V) with the temperature set at 170-220° C. to make the test specimens/samples.

General Procedure for Foaming Test Method

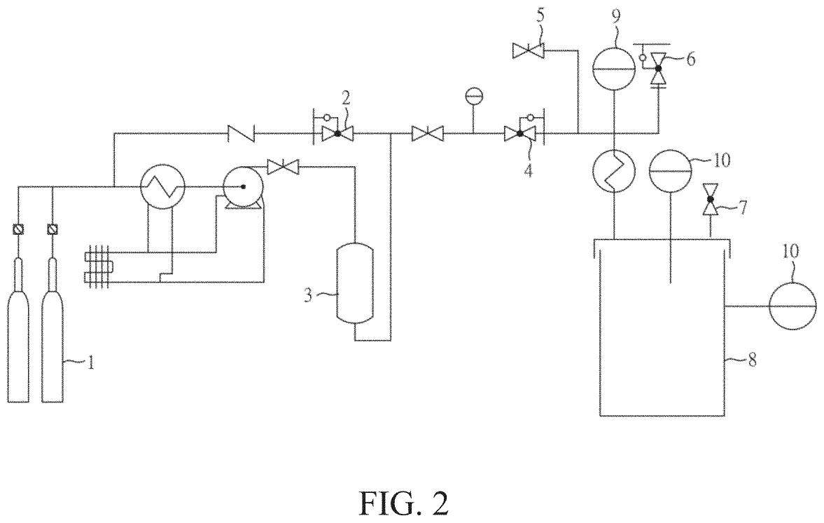

Foamed, molded polypropylene examples were produced using a batch physical foaming process (see foaming device shown in FIG. 2). The foaming device at least comprises: a CO₂ cylinder 1; a back pressure valve 2; a buffer tank 3; a pressure adjustable valve 4; a compressed air valve 5; a safety valve 6; a pressure discharged valve 7; a reactor 8; a pressure detector 9; and temperature detectors 10.

The dimension of the mold was 210 mm×210 mm×20 mm. The foaming parameters in the batch physical foaming process were optimized based on experience with the polypropylene type (homopolymer, random copolymer, random terpolymer, impact copolymer) and of the modifier (Thermoplastic Elastomer (TPE), Polyolefin Elastomer (POE), etc.) used. The key parameters controlled in the batch physical foaming process were temperature, pressure, foaming time, and pressure discharging time. The foaming temperature was generally 5˜10° C. below the melting point (Tm) of the polypropylene resin. For example, the melting points for non-modified polypropylene homopolymer was 163˜167° C.; for non-modified random copolymer of polypropylene was 145˜150° C.; for non-modified Heterophasic Copolymer (HECO) of polypropylene was 160˜165° C.; and for a non-modified random terpolymer of polypropylene was 130˜138° C. The physical blowing agent was, unless noted otherwise below, CO₂ in its supercritical condition.

### Example 1

The polypropylene resins and nucleating agent formulations as provided in this example were well-mixed in a high speed Henschel mixer for 30˜60 seconds. The mixtures (10 kg each) were then put into the hopper of a co-rotating twin-screw extruder (L/D: 37, KM Berstorff ZE40A) with the temperature set at 160-200° C. for propylene homopolymer (WB140, Globalene® PC366-3,1120)-based compositions and for heterophasic polypropylene copolymer (7633U)-based compositions and the screw rotational speed set at 300 rpm to obtain micro-pellet (non-foamed) samples. For random copolymer of polypropylene (Globalene® ST611) the temperature was set at 160˜180° C. and the screw rotational speed set at 260 rpm. The micro-pellets were then put into the hopper of an injection molding machine (Chen Hsong Machinery, SM120V) with temperature was set to 170-220° C. to make the test specimens/samples. Table 1 below provides a summary of the polymer compositions (e.g., polypropylene with or without nucleating agents) disclosed in Examples 1-1, 1-2, 1-3, and 1-4.

TABLE 1

| | | | | | | Engage | | |
|---|---|---|---|---|---|---|---|---|
| | PC366-3 | ST611 | MB50-001 | MB50-321 | NX8000 | 8150 | NAB-82 | NU-100 |
| Sample | (wt %) | (wt %) | (wt %) | (wt %) | (wt %) | (wt %) | (wt %) | (wt %) |
| Example | | 92 | 1 | | 2 | 5 | | |
| 1-1 | | | | | | | | |
| Example | 89.35 | 10 | | 0.5 | 0.05 | | | 0.1 |
| 1-2 | | | | | | | | |
| Example | | 87 | 1 | | 2 | 10 | | |
| 1-3 | | | | | | | | |
| Example | | 99.9 | | | | | 0.1 | |
| 1-4 | | | | | | | | |

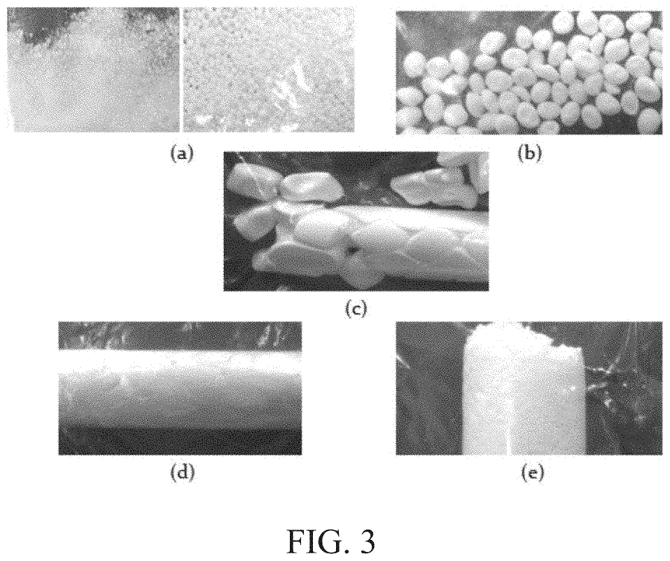

Tables 2 and 3 below provide a summary of the polymer compositions for the samples tested, additional details regarding process conditions (i.e., temperature, time, and pressure), and the properties of the resulting polypropylene foamed samples (i.e., density in Table 2 and appearance in Table 3). FIG. 3 shows the appearance (i.e., labeled as “a”, “b”, “c”, “d” and “e”) of the samples tested in this example.

TABLE 2

| | Foaming Conditions | | | | | | | |
|---|---|---|---|---|---|---|---|---|
| | 2050 psi | | | | | | | |
| | 130° C. | 135° C. | 140° C. | 145° C. | 150° C. | 155° C. | 160° C. | |
| | 30 | 30 | 30 | 30 | 30 | 30 | 30 | 10 |
| Sample | min | min | min | min | min | min | min | min |
| Comparative | | | | | 0.184¹ | 0.193¹ | 0.040¹ | |
| Example 1-1 | | | | | | | | |
| (WB140) | | | | | | | | |
| Comparative | | | | | 0.476¹ | 0.082¹ | 0.043¹ | |
| Example 1-2 | | | | | | | | |
| (PC366-3 | | | | | | | | |
| (g)) | | | | | | | | |
| Comparative | | | | | 0.757¹ | 0.225¹ | 0.075¹ | |
| Example 1-3 | | | | | | | | |
| (PC366-3 | | | | | | | | |
| (β)) | | | | | | | | |
| Comparative | 0.177¹ | 0.114¹ | 0.067¹ | 0.063¹ | | | | |
| Example 1-4 | | | | | | | | |
| (ST611 (β)) | | | | | | | | |
| Comparative | | | | | — | — | — | — |
| Example 1-5 | | | | | | | | |
| (7633U) | | | | | | | | |
| flake | | | | | | | | |
| Comparative | | | | | — | — | — | — |
| Example 1-6 | | | | | | | | |
| (PC366-3) | | | | | | | | |
| flake | | | | | | | | |
| Comparative | | | | | — | — | Fused | |
| Example 1-7 | | | | | | | | |
| (1120) | | | | | | | | |
| pellets | | | | | | | | |
| Example 1-1 | 0.727¹ | 0.323¹ | 0.090¹ | 0.038¹ | | | | |
| Example 1-2 | | | | | — | 0.162¹ | 0.059¹ | 0.06¹ |
| Example 1-3 | 0.268¹ | 0.138¹ | 0.079¹ | 0.102¹ | | | | |
| Example 1-4 | 0.179¹ | 0.139¹ | 0.080¹ | 0.084¹ | | | | |

¹density (g/cm³)

TABLE 3

| | Foaming Conditions | | | | | | | |
|---|---|---|---|---|---|---|---|---|
| | 2050 psi | | | | | | | |
| | 130° C. | 135° C. | 140° C. | 145° C. | 150° C. | 155° C. | 160° C. | |
| | 30 | 30 | 30 | 30 | 30 | 30 | 30 | 10 |
| Sample | min | min | min | min | min | min | min | min |
| Comparative | | | | | b | c | d | d |
| Example 1-1 | | | | | | | | |
| (WB140) | | | | | | | | |
| Comparative | | | | | b | c | d | d |
| Example 1-2 | | | | | | | | |
| (PC366-3 (g)) | | | | | | | | |
| Comparative | | | | | b | c | d | d |
| Example 1-3 | | | | | | | | |
| (PC366-3 (β)) | | | | | | | | |
| Comparative | b | c | c | d | | | | |
| Example 1-4 | | | | | | | | |
| (ST611 (β)) | | | | | | | | |
| Comparative | | | | | a | a | a | a |
| Example 1-5 | | | | | | | | |
| (7633U) flake | | | | | | | | |
| Comparative | | | | | a | a | a | a |
| Example 1-6 | | | | | | | | |
| (PC366-3) | | | | | | | | |
| flake | | | | | | | | |
| Comparative | | | | | a | a | e | |
| Example 1-7 | | | | | | | | |
| (1120 | | | | | | | | |
| Micro-pellets) | | | | | | | | |
| Example 1-1 | b | b | c | d | | | | |
| Example 1-2 | | | | | b | c | d | d |
| Example 1-3 | b | b | c | d | | | | |
| Example 1-4 | b | c | c | d | | | | |

Results and Discussion

The results summarized in Tables 2 and 3 show that the foaming of polypropylene flakes (Comparative Example 1-6 (PC366-3) flake, Comparative Example 1-5 (7633U) flake, and Comparative Example 1-7 (1120)) was poor. These samples could not be foamed at 150˜160° C. It was observed that for Comparative Example 1-1 (WB140, which is an HMSPP made by Borealis) the pellet fusion temperature should be between 155 and 160° C. The foaming results obtained for Example 1-2 are similar to those of Comparative Example 1-1, but the foaming result of Comparative Example 1-3 (PC366-3 (β)) was somewhat poor. It is noted for Table 2 that some spaces are blank because the tested samples could not be foamed and/or the foaming was not good at certain temperatures.

Conversely, the results show for ST611 base formulations (Example 1-1, Example 1-3, Example 1-4) that the foaming result was similar to Comparative Example 1-1 even though the Example 1-1, Example 1-3, and Example 1-4 were foamed at a lower temperature range. This was possible because Example 1-1, Example 1-3, and Example 1-4 had a lower Tin than Comparative Example 1-1.

It was further observed that the stiffness of foamed, molded products of Comparative Example 1-3 (PC366-3 (β)) and Example 1-2 were better than those made of Comparative Example 1-1 and Comparative Example 1-2 (PC366-3 (g)). Surprisingly, even the foaming samples of Example 1-1, Example 1-3, Example 1-4 were stiffer than the sample foamed by Comparative Example 1-1.

### Example 2

The polypropylene resins and nucleating agent formulations as provided in this example were well-mixed in a high speed Henschel mixer for 30˜60 seconds. The mixtures (10 kg each) were then put into the hopper of a co-rotating twin screw extruder (L/D: 37, KM Berstorff ZE40A) with the temperature set at 160-200° C. for propylene homopolymer (Globalene® PC366-3)-based compositions and the screw rotational speed set at 300 rpm to obtain micro-pellet samples. For random copolymer of polypropylene (Globalene® ST611)—based compositions, the temperature was set at 160˜180° C. and the screw rotational speed was set at 260 rpm. The micro-pellets were then put into the hopper of an injection molding machine (Chen Hsong Machinery, SM120V) with temperature set at 170-220° C. to make the test specimens/samples. Table 4 below provides a summary of the polymer compositions (e.g., polypropylene with or without nucleating agents) disclosed in Examples 2-1, 2-2, and 2-3. Tables 5, 6, and 7 below provide a summary of the process conditions (i.e., temperature, time, and pressure) and the density of the resulting samples.

TABLE 4

| | PC366- | | Lotryl | MB50- | | NAB- | NU- |
|---|---|---|---|---|---|---|---|
| Sam- | 3 | ST611 | 29MA03 | 321 | NX8000 | 82 | 100 |
| ple | (wt %) | (wt %) | (wt %) | (wt %) | (wt %) | (wt %) | (wt %) |
| Ex- | 88.85 | 10 | | 1 | 0.05 | | 0.1 |
| am- | | | | | | | |
| ple | | | | | | | |
| 2-1 | | | | | | | |
| Ex- | | 95 | 5 | | | | |
| am- | | | | | | | |
| ple | | | | | | | |
| 2-2 | | | | | | | |
| Ex- | 89.85 | 10 | | | 0.05 | 0.1 | |
| am- | | | | | | | |
| ple | | | | | | | |
| 2-3 | | | | | | | |

TABLE 5

| | PC366- | | Lotryl | MB50- | | NAB- | NU- |
|---|---|---|---|---|---|---|---|
| Sam- | 3 | ST611 | 29MA03 | 321 | NX8000 | 82 | 100 |
| ple | (wt %) | (wt %) | (wt %) | (wt %) | (wt %) | (wt %) | (wt %) |
| Ex- | 88.85 | 10 | | 1 | 0.05 | | 0.1 |
| am- | | | | | | | |
| ple | | | | | | | |
| 2-1 | | | | | | | |
| Ex- | | 95 | 5 | | | | |
| am- | | | | | | | |
| ple | | | | | | | |
| 2-2 | | | | | | | |
| Ex- | 89.85 | 10 | | | 0.05 | 0.1 | |
| am- | | | | | | | |
| ple | | | | | | | |
| 2-3 | | | | | | | |

Example 2-1 (powder) cannot be foamed at the foaming conditions listed in Table 4.

TABLE 6

| | Foaming Conditions | | | |
|---|---|---|---|---|
| | | | | Density |
| Sample | Temp. (° C.) | Pressure (psi) | Time (min.) | (g/cm³) |
| Example 2-2 | 135 | 2050 | 30 | 0.265 |
| (45) | | | | |
| Example 2-2 | 135 | 2050 | 30 | 0.385 |
| (30) | | | | |
| Example 2-2 | 135 | 2050 | 30 | 0.355 |
| (20) | | | | |
| Example 2-2 | 140 | 2050 | 30 | 0.093 |
| (45) | | | | |
| Example 2-2 | 140 | 2050 | 30 | 0.139 |
| (30) | | | | |
| Example 2-2 | 140 | 2050 | 30 | 0.119 |
| (20) | | | | |

Note:
45, 30, 20 represent the different extrusion output rates (kg/hr), which defined micro-pellet size.

TABLE 7

| | Foaming Conditions | | | |
|---|---|---|---|---|
| | | | | Density |
| Sample | Temp. (° C.) | Pressure (psi) | Time (min.) | (g/cm³) |
| Example 2-3 | 145 | 2050 | 30 | 0.858 |
| (45) | | | | |
| Example 2-3 | 145 | 2050 | 30 | — |
| (30) | | | | |
| Example 2-3 | 145 | 2050 | 30 | — |
| (20) | | | | |
| Example 2-3 | 150 | 2050 | 30 | 0.701 |
| (45) | | | | |
| Example 2-3 | 150 | 2050 | 30 | 0.742 |
| (30) | | | | |
| Example 2-3 | 150 | 2050 | 30 | — |
| (20) | | | | |
| Example 2-3 | 155 | 2050 | 30 | 0.352 |
| (45) | | | | |
| Example 2-3 | 155 | 2050 | 30 | 0.270 |
| (30) | | | | |
| Example 2-3 | 155 | 2050 | 30 | 0.339 |
| (20) | | | | |
| Example 2-3 | 160 | 2050 | 30 | 0.066 |
| (45) | | | | |
| Example 2-3 | 160 | 2050 | 30 | 0.072 |
| (30) | | | | |
| Example 2-3 | 160 | 2050 | 30 | 0.077 |
| (20) | | | | |
| Example 2-3 | 160 | 2050 | 5 | 0.080 |
| (45) | | | | |
| Example 2-3 | 160 | 2050 | 5 | 0.109 |
| (30) | | | | |
| Example 2-3 | 160 | 2050 | 5 | 0.162 |
| (20) | | | | |
| Example 2-3 | 160 | 2050 | 2 | 0.110 |
| (45) | | | | |
| Example 2-3 | 160 | 2050 | 2 | 0.116 |
| (30) | | | | |
| Example 2-3 | 160 | 2050 | 2 | 0.107 |
| (20) | | | | |
| Example 2-3 | 160 | 1040 | 30 | 0.319 |
| (45) | | | | |
| Example 2-3 | 160 | 1040 | 30 | 0.393 |
| (30) | | | | |
| Example 2-3 | 160 | 1040 | 30 | 0.437 |
| (20) | | | | |
| Example 2-3 | 160 | 1040 | 2 | — |
| (45) | | | | |
| Example 2-3 | 160 | 1040 | 2 | — |
| (30) | | | | |
| Example 2-3 | 160 | 1040 | 2 | — |
| (20) | | | | |
| Example 2-3 | 160 | 2050 | 30 | 0.055 |
| (45) | | | | |
| Example 2-3 | 160 | 2050 | 30 | 0.085 |
| (30) | | | | |
| Example 2-3 | 160 | 2050 | 30 | 0.102 |
| (fine) | | | | |

Note:
“fine” means that the pellet size is half of the pellet size obtained when the output rate is “20” kg/hr

Results and Discussion

It is noted that the smaller the particle size of the micro-pellet (non-foamed), the lower the expansion ratio at the same foaming conditions. This may be attributed to the lower gas solubility. Example 2-1 (powder) (see Table 5) could not be foamed even when the temperature was increased to 160° C. It was also found that Example 2-3 (Table 7) could not be foamed when the foaming pressure was reduced from 2050 psi to 1040 psi if the foaming time was reduced to 2 minutes.

It was also found that the micro-pellets' fusion capability was better when the micro-pellet size, before foaming, was bigger, as defined by the extrusion output rate. It is noted that the lower the extrusion output rate, the smaller the micro-pellet. This study examined the size of the pellets micro-pellets made and compared their foamability. The stiffness of the foam was softer to the touch for the Comparative Example 1-1 (WB140) versus the foamed samples made in this example.

### Example 3

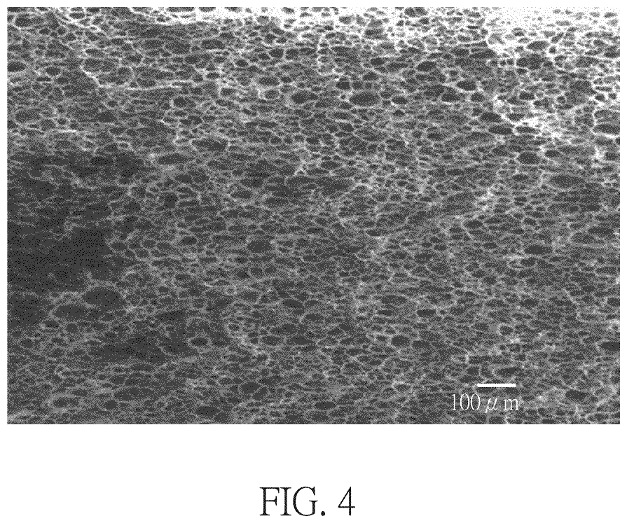

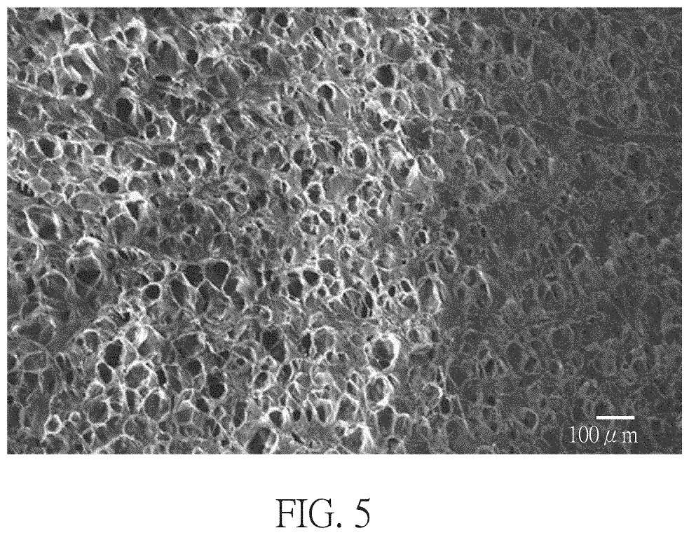

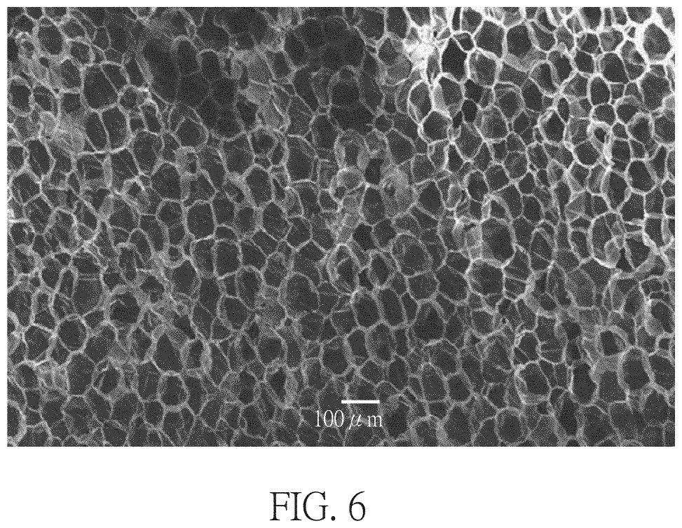

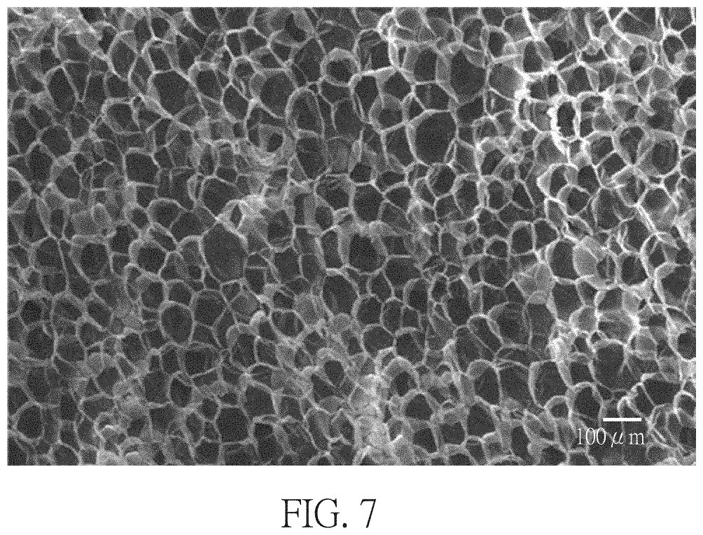

The polypropylene resins and modifier formulations as provided in this example (Example 3-1: Globalene® ST866; Example 3-2: 8491 (Globalene® ST866+4% Engage 8401); Example 3-3: 8492 (Globalene® ST866+5% Lotryl 29MA03); and Example 3-4: ST8461 (Globalene® ST866+6.5% SEBS G1645M)) were well-mixed in a high speed Henschel mixer for 60 seconds. The mixtures (10 kg each) were then put into the hopper of a co-rotating twin-screw extruder (L/D: 37, KM Berstorff ZE40A) with the temperature set at 160˜180° C. and the screw rotational speed set at 260 rpm. The micro-pellets were then put into the hopper of an injection molding machine (Chen Hsong Machinery, SM120V with temperature set at 170-220° C. to make the test specimens. The formulations tested in this example contained modified formulations (e.g., random copolymer of polypropylene+modifier (TPE, POE, etc.), other polymers). Table 8 below provides a summary of the compositions made and the density of the resulting polypropylene foams. The SEM images of the polypropylene foams of Example 3-1, Example 3-2, Example 3-3, and Example 3-4 are shown in FIGS. 4, 5, 6, and 7, respectively. Herein, FIG. 4 shows an SEM image of a polypropylene foam made according to an exemplary batch process of Example 3-1, in which the foaming pressure is 2050 Psi, the foaming temperature is 150° C. and the foaming time is 20 min. FIG. 5 shows an SEM image of a polypropylene foam made according to an exemplary batch process of Example 3-2, in which the foaming pressure is 2050 Psi, the foaming temperature is 150° C. and the foaming time is 10 min. FIG. 6 shows an SEM image of a polypropylene foam made according to an exemplary batch process of Example 3-3, in which the foaming pressure is 2050 Psi, the foaming temperature is 150° C. and the foaming time is 30 min. FIG. 7 shows an SEM image of a polypropylene foam made according to an exemplary batch process of Example 3-4, in which the foaming pressure is 2050 Psi, the foaming temperature is 150° C. and the foaming time is 30 min.

TABLE 8

| | Pressure | Temperature | Foaming Time | Density |
|---|---|---|---|---|
| Sample | (psi) | (° C.) | (min) | (g/cm³) |
| Example | 2050 | 145° C. | 30 | 0.120 |
| 3-1 | | | | |
| Example | 2050 | 145° C. | 30 | 0.139 |
| 3-2 | | | | |
| Example | 2050 | 145° C. | 30 | 0.140 |
| 3-3 | | | | |
| Example | 2050 | 145° C. | 30 | 0.150 |
| 3-4 | | | | |
| Example | 2050 | 145° C. | 20 | 0.143 |
| 3-1 | | | | |
| Example | 2050 | 145° C. | 20 | 0.117 |
| 3-2 | | | | |
| Example | 2050 | 145° C. | 20 | 0.202 |
| 3-3 | | | | |
| Example | 2050 | 145° C. | 20 | 0.137 |
| 3-4 | | | | |
| Example | 2050 | 140° C. | 30 | 0.267 |
| 3-1 | | | | |
| Example | 2050 | 140° C. | 30 | 0.235 |
| 3-2 | | | | |
| Example | 2050 | 140° C. | 30 | 0.255 |
| 3-3 | | | | |
| Example | 2050 | 140° C. | 30 | 0.280 |
| 3-4 | | | | |
| Example | 2050 | 150° C. | 30 | 0.075 |
| 3-1 | | | | |
| Example | 2050 | 150° C. | 30 | 0.081 |
| 3-2 | | | | |
| Example | 2050 | 150° C. | 30 | 0.086 |
| 3-3 | | | | |
| Example | 2050 | 150° C. | 30 | 0.081 |
| 3-4 | | | | |
| Example | 2050 | 150° C. | 20 | 0.074 |
| 3-1 | | | | |
| Example | 2050 | 150° C. | 20 | 0.072 |
| 3-2 | | | | |
| Example | 2050 | 150° C. | 20 | 0.109 |
| 3-3 | | | | |
| Example | 2050 | 150° C. | 20 | 0.099 |
| 3-4 | | | | |
| Example | 2050 | 150° C. | 10 | 0.076 |
| 3-1 | | | | |
| Example | 2050 | 150° C. | 10 | 0.078 |
| 3-2 | | | | |
| Example | 2050 | 150° C. | 10 | 0.097 |
| 3-3 | | | | |
| Example | 2050 | 150° C. | 10 | 0.122 |
| 3-4 | | | | |
| Example | 2050 | 150° C. | 5 | 0.101 |
| 3-1 | | | | |
| Example | 2050 | 150° C. | 5 | 0.143 |
| 3-2 | | | | |
| Example | 2050 | 150° C. | 5 | 0.199 |
| 3-3 | | | | |
| Example | 2050 | 150° C. | 5 | 0.120 |
| 3-4 | | | | |
| Example | 1025 | 150° C. | 15 | 0.271 |
| 3-1 | | | | |
| Example | 1025 | 150° C. | 15 | 0.241 |
| 3-2 | | | | |
| Example | 1025 | 150° C. | 15 | 0.291 |
| 3-3 | | | | |
| Example | 1025 | 150° C. | 15 | 0.315 |
| 3-4 | | | | |
| Example | 1025 | 150° C. | 5 | 0.300 |
| 3-1 | | | | |
| Example | 1025 | 150° C. | 5 | 0.260 |
| 3-2 | | | | |
| Example | 1025 | 150° C. | 5 | 0.256 |
| 3-3 | | | | |
| Example | 1025 | 150° C. | 5 | 0.330 |
| 3-4 | | | | |
| Example | 1025 | 155° C. | 10 | 0.197 |
| 3-1 | | | | |
| Example | 1025 | 155° C. | 10 | 0.195 |
| 3-2 | | | | |
| Example | 1025 | 155° C. | 10 | 0.197 |
| 3-3 | | | | |
| Example | 1025 | 155° C. | 10 | 0.194 |
| 3-4 | | | | |
| Example | 1025 | 155° C. | 5 | 0.299 |
| 3-1 | | | | |
| Example | 1025 | 155° C. | 5 | 0.286 |
| 3-2 | | | | |
| Example | 1025 | 155° C. | 5 | 0.268 |
| 3-3 | | | | |
| Example | 1025 | 155° C. | 5 | 0.321 |
| 3-4 | | | | |
| Example | 1025 | 160° C. | 5 | 0.295 |
| 3-1 | | | | |
| Example | 1025 | 160° C. | 5 | 0.240 |
| 3-2 | | | | |
| Example | 1025 | 160° C. | 5 | 0.246 |
| 3-3 | | | | |
| Example | 1025 | 165° C. | 5 | 0.280 |
| 3-4 | | | | |
| Example | 1025 | 165° C. | 5 | 0.278 |
| 3-1 | | | | |
| Example | 1025 | 165° C. | 5 | 0.210 |
| 3-2 | | | | |
| Example | 1025 | 165° C. | 5 | 0.232 |
| 3-3 | | | | |
| Example | 1025 | 165° C. | 5 | 0.227 |
| 3-4 | | | | |

Results and Discussion

As can be seen from the results, the polypropylene foam of Example 3-3 behaves better in density reduction among the four resins tested under the same foaming conditions. In addition, from the foaming test result of Example 3-1, Example 3-2, Example 3-3, and Example 3-4, the modified formulations of Example 3-2, Example 3-3, and Example 3-4 only slightly improve when reducing the foaming pressure and foaming time down to 1025 psi and 5 min.

It is noted that compared to Example 3-1, in Example 3-2, Example 3-3, and Example 3-4, Engage 8401, Lotryl 29MA03, and SEBS G1645M, respectively, were added. These were added in an attempt to increase the amorphous zone in the polymer matrix, which in turn could potentially increase the CO₂ solubility and could get lower foam density at relatively low foaming pressure and foaming time.

### Example 4

The polypropylene resins and modifier formulations as provided in this example were well-mixed in a high speed Henschel mixer for 30 seconds. The mixtures (10 kg each) were then put into the hopper of a co-rotating twin-screw extruder (L/D: 37, KM Berstorff ZE40A) with the temperature set at 160˜180° C. and the screw rotational speed set at 260 rpm. The micro-pellets were then put into the hopper of injection molding machine (Chen Hsong Machinery, SM120V) with the temperature set at 170-220° C. to make the test specimens. Table 9 below provides a summary of the polymer compositions (e.g., polypropylene with or without nucleating agents) disclosed in Examples 4-1, 4-2, 4-3, 4-4 and 4-5. Tables 10 and 11 below provide a summary of the process conditions (i.e., temperature, time, and pressure) and the density of the resulting foamed, molded products.

TABLE 9

| | ST612 | ST611 | Evaloy 3427 | NX8000 | NAB-82 |
|---|---|---|---|---|---|
| Sample | (wt %) | (wt %) | (wt %) | (wt %) | (wt %) |
| Example 4-1 | 95 | | 5 | | |
| Example 4-2 | 94.85 | | 5 | 0.05 | 0.1 |
| Example 4-3 | 90 | | 10 | | |
| Example 4-4 | | 80 | 20 | | |
| Example 4-5 | | 70 | 30 | | |

TABLE 10

| | Pressure | Temperature | Time | Density |
|---|---|---|---|---|
| Sample | (psi) | (° C.) | (min) | (g/cm³) |
| Example 4-1 | 2050 | 150° C. | 30 | 0.070 |
| Example 4-2 | 2050 | 150° C. | 30 | 0.068 |
| Example 4-3 | 2050 | 150° C. | 30 | 0.059 |
| Example 4-1 | 2050 | 150° C. | 5 | 0.173 |
| Example 4-2 | 2050 | 150° C. | 5 | 0.107 |
| Example 4-3 | 2050 | 150° C. | 5 | 0.077 |
| Example 4-3 | 2050 | 150° C. | 5 | 0.077 |
| PIF | | | | |
| Example 4-1 | 1025 | 150° C. | 5 | 0.432 |
| Example 4-2 | 1025 | 150° C. | 5 | 0.282 |
| Example 4-3 | 1025 | 150° C. | 5 | 0.336 |
| Example 4-3 | 1025 | 150° C. | 5 | 0.421 |
| PIF | | | | |
| Example 4-1 | 1025 | 155° C. | 5 | 0.226 |
| Example 4-2 | 1025 | 155° C. | 5 | 0.206 |
| Example 4-3 | 1025 | 155° C. | 5 | 0.223 |
| Example 4-3 | 1025 | 155° C. | 5 | 0.421 |
| PIF | | | | |
| Example 4-1 | 1025 | 160° C. | 10 | 0.147 |
| Example 4-2 | 1025 | 160° C. | 10 | 0.104 |
| Example 4-3 | 1025 | 160° C. | 10 | 0.098 |
| Example 4-3 | 1025 | 160° C. | 10 | 0.091 |
| PIF | | | | |
| Example 4-1 | 1025 | 160° C. | 5 | 0.142 |
| Example 4-2 | 1025 | 160° C. | 5 | 0.109 |
| Example 4-3 | 1025 | 160° C. | 5 | 0.104 |
| Example 4-3 | 1025 | 160° C. | 5 | 0.105 |
| PIF | | | | |
| Example 4-1 | 1025 | 165° C. | 5 | 0.094 |
| Example 4-2 | 1025 | 165° C. | 5 | 0.083 |
| Example 4-3 | 1025 | 165° C. | 5 | 0.089 |
| Example 4-3 | 1025 | 165° C. | 5 | 0.098 |
| PIF | | | | |
| Example 4-1 | 750 | 160° C. | 5 | 0.216 |
| Example 4-2 | 750 | 160° C. | 5 | 0.162 |
| Example 4-3 | 750 | 160° C. | 5 | 0.189 |
| Example 4-3 | 750 | 160° C. | 5 | 0.213 |
| PIF | | | | |
| Example 4-4 | 2050 | 145° C. | 30 | 0.123 |
| Example 4-5 | 2050 | 145° C. | 30 | 0.110 |
| X1956A(TPE) | 2050 | 145° C. | 30 | 0.654 |
| Example 4-1 | 1025 | 145° C. | 30 | 0.144 |
| Example 4-3 | 1025 | 145° C. | 30 | 0.134 |
| Example 4-4 | 1025 | 145° C. | 30 | 0.282 |
| Example 4-5 | 1025 | 145° C. | 30 | 0.405 |
| Example 4-1 | 1025 | 150° C. | 30 | 0.091 |
| Example 4-4 | 1025 | 150° C. | 30 | 0.083 |
| Example 4-4 | 1025 | 150° C. | 30 | 0.186 |
| Example 4-5 | 1025 | 150° C. | 30 | 0.206 |
| Example 4-1 | 1025 | 150° C. | 5 | 0.250 |
| Example 4-3 | 1025 | 150° C. | 5 | 0.246 |
| Example 4-4 | 1025 | 150° C. | 5 | 0.179 |
| Example 4-5 | 1025 | 150° C. | 5 | 0.242 |
| X1956A | 1025 | 155° C. | 5 | 0.624 |
| Example 4-3 | 1025 | 155° C. | 5 | 0.156 |
| Example 4-4 | 1025 | 155° C. | 5 | 0.194 |
| Example 4-5 | 1025 | 155° C. | 5 | 0.181 |
| X1956A | 1025 | 160° C. | 5 | 0.602 |
| PT181 PIF T1 | 1025 | 160° C. | 5 | 0.890 |
| Example 4-4 | 1025 | 160° C. | 5 | 0.077 |
| Example 4-5 | 1025 | 160° C. | 5 | 0.068 |
| Example 4-4 | 750 | 160° C. | 5 | 0.497 |
| Example 4-5 | 750 | 160° C. | 5 | 0.444 |
| Example 4-4 | 750 | 165° C. | 5 | 0.511 |
| Example 4-5 | 750 | 165° C. | 5 | 0.269 |

PIF stands for Pressure Induced Flow.

X1956A is a TPE material from LyondellBasell Catalloy process.

PT181 PIF T1 is a homopolymer PP (PT181 MFR 0.4) from LCY which is pre-treated by PIF before foaming

Blowing agent used was CO₂.

TABLE 11

| | Pressure | Temperature | Time | Density |
|---|---|---|---|---|
| Sample | (psi) | (° C.) | (min) | (g/cm³) |
| Example 4-1 | 2050 | 160° C. | 30 | 0.153 |
| Example 4-3 | 2050 | 160° C. | 30 | 0.161 |
| Example 4-4 | 2050 | 160° C. | 30 | 0.144 |
| Example 4-5 | 2050 | 160° C. | 30 | 0.152 |
| Example 4-1 | 2050 | 170° C. | 30 | 0.692 |
| Example 4-3 | 2050 | 170° C. | 30 | 0.696 |
| Example 4-4 | 2050 | 170° C. | 30 | 0.662 |
| Example 4-5 | 2050 | 170° C. | 30 | 0.678 |
| Example 4-1 | 2050 | 165° C. | 30 | 0.119 |
| Example 4-3 | 2050 | 165° C. | 30 | 0.042 |
| Example 4-4 | 2050 | 165° C. | 30 | 0.068 |
| Example 4-5 | 2050 | 165° C. | 30 | 0.113 |
| Example 4-1 | 1750 | 165° C. | 30 | 0.120 |
| Example 4-3 | 1750 | 165° C. | 30 | 0.127 |
| Example 4-4 | 1750 | 165° C. | 30 | 0.047 |
| Example 4-5 | 1750 | 165° C. | 30 | 0.101 |
| Example 4-3 | 725 | 165° C. | 30 | 0.039 |
| Example 4-4 | 725 | 165° C. | 30 | 0.044 |
| Example 4-5 | 725 | 165° C. | 30 | 0.033 |
| Example 4-3 | 725 | 165° C. | 10 | 0.048 |
| Example 4-4 | 725 | 165° C. | 10 | 0.034 |
| Example 4-5 | 725 | 165° C. | 10 | 0.041 |
| Example 4-3 | 500 | 165° C. | 10 | 0.081 |
| Example 4-4 | 500 | 165° C. | 10 | 0.064 |
| Example 4-5 | 500 | 165° C. | 10 | 0.061 |
| Example 4-3 | 500 | 165° C. | 5 | 0.479 |
| Example 4-4 | 500 | 165° C. | 5 | 0.129 |
| Example 4-5 | 500 | 165° C. | 5 | 0.207 |
| Example 4-3 | 400 | 165° C. | 10 | 0.721 |
| Example 4-4 | 400 | 165° C. | 10 | 0.709 |
| Example 4-5 | 400 | 165° C. | 10 | 0.689 |
| Example 4-3 | 400 | 170° C. | 10 | 0.854 |
| Example 4-4 | 400 | 170° C. | 10 | 0.910 |
| Example 4-5 | 400 | 170° C. | 10 | 0.843 |

Blowing agent was R134A.

Results and Discussion

As can be seen from Table 10, for Examples 4-1, 4-2, 4-3, 4-4, and 4-5 when the samples were foamed at 150° C. the foam pressure and foaming time could be reduced to 1025 psi and 5 minutes to give a foam density of 0.179˜0.250 g/cm³. As the ethylene butyl acrylate (EBA) content was increased (e.g., the % of AC 3427 was increased from 5% (Examples 4-1 and 4-2) to 10% (Example 4-3)), the CO₂ solubility was gradually increased and then the pressure and foaming time could be reduced at certain temperature settings (see Table 10).

Surprisingly, it was found that the foaming pressure of the same formulations could be further reduced to 500 psi when the blowing agent was changed from CO₂ to HFC (R134A) (see Table 11) even though the foaming time was slightly increased up to 10 min, thus gradually approaching commercial foaming conditions.

### Example 5

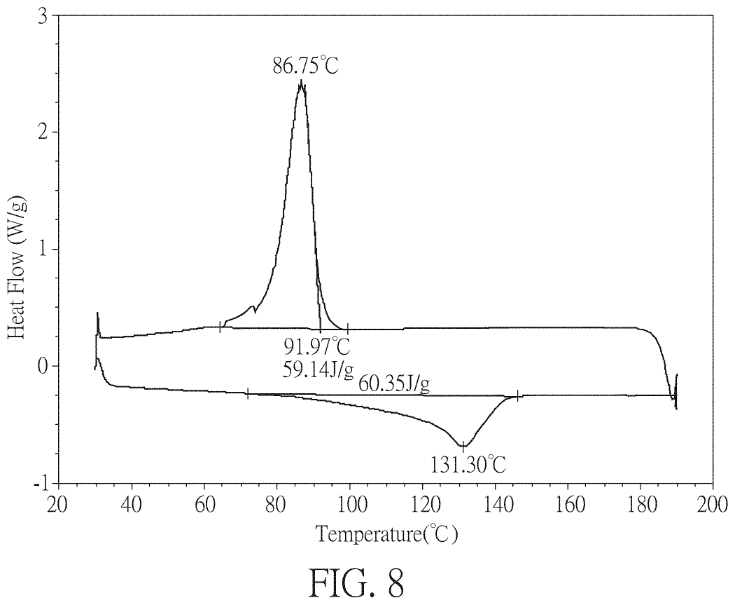

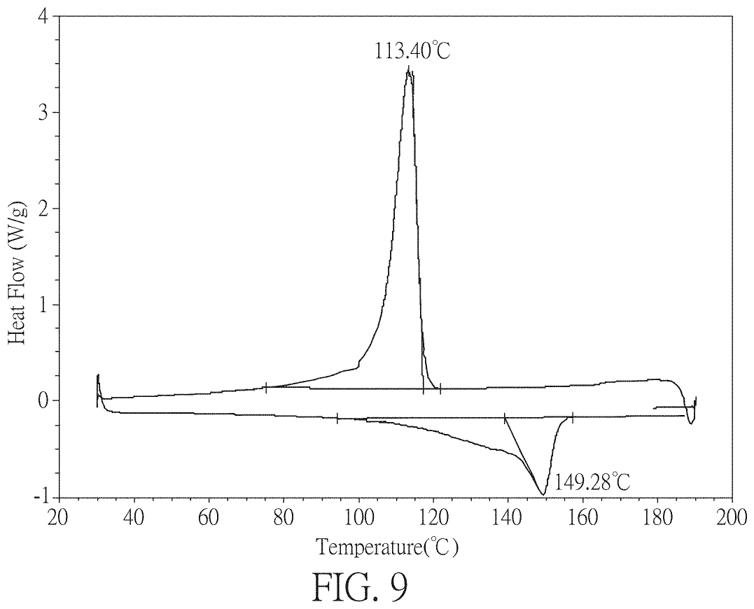

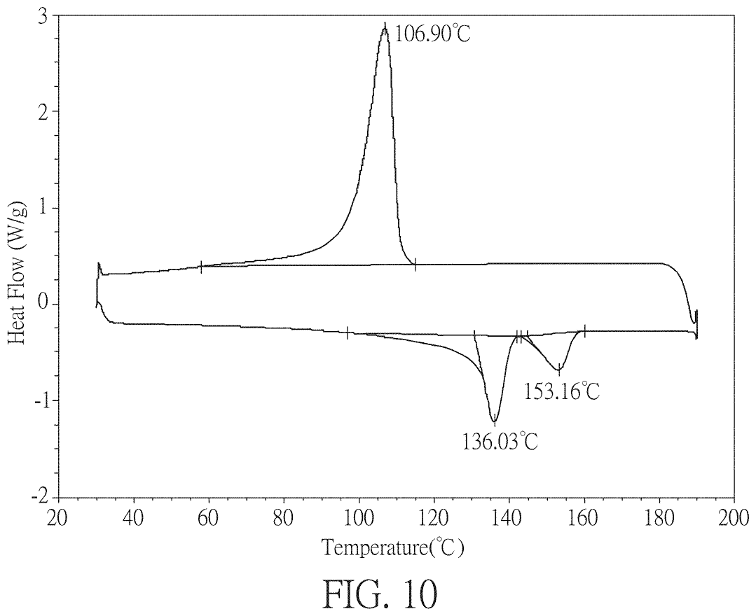

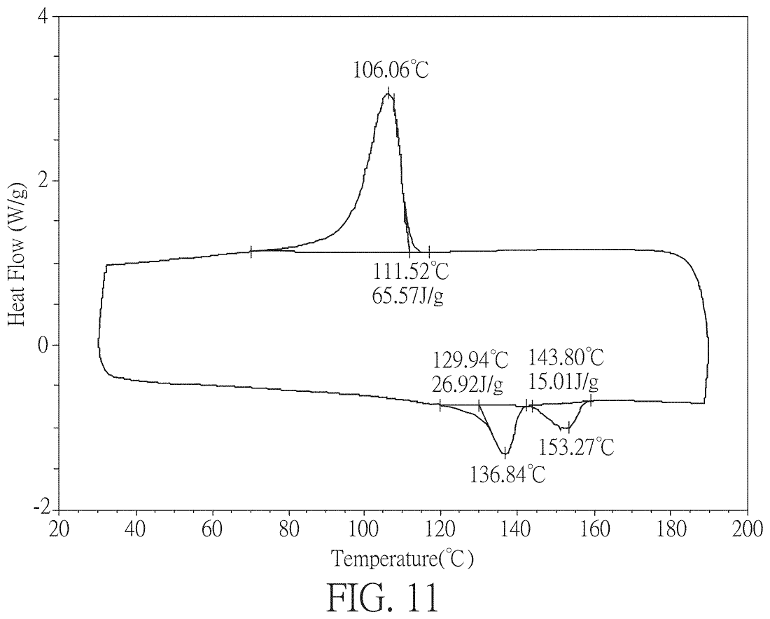

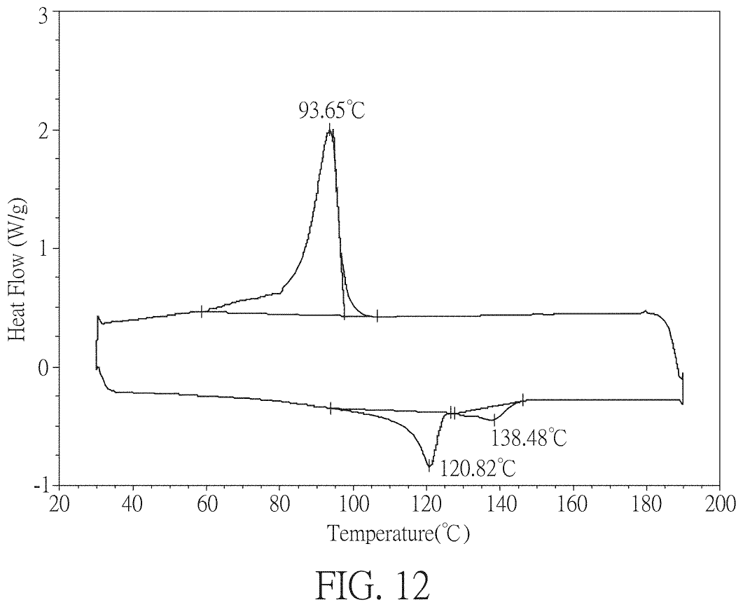

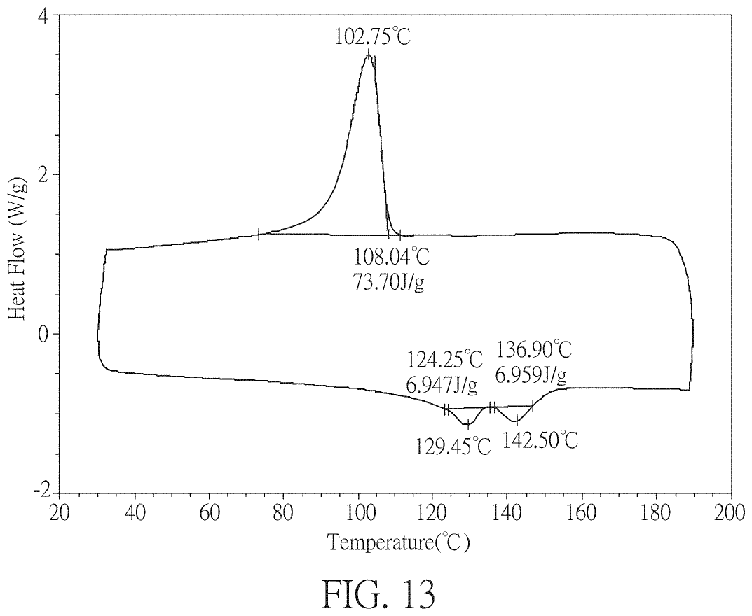

The polypropylene resins and the nucleating agent formulations as provided in this example were well-mixed in a high speed Henschel mixer for 30 seconds. The mixtures (10 kg each) were then put into the hopper of a co-rotating twin-screw extruder (L/D: 37, KM Berstorff ZE40A) with the temperature set at 160˜180° C. and the screw rotational speed set at 260 rpm for a random copolymer of polypropylene. However, for random terpolymer of polypropylene the temperature setting was 150˜170° C. In addition, the extruded non-foamed micro-pellet size of the random terpolymer of polypropylene was in a range from 0.25 mm to 0.85 mm. The micro-pellets were then put into the hopper of injection molding machine (Chen Hsong Machinery, SM120V) with temperature setting at 170-220° C. to make the test specimens. Tables 12 and 13 below provide a summary of the polymer compositions (e.g., specific value of each ingredient, such as nucleating agents, C2, C3, and C4 (wt %)) disclosed in Examples 5-1, 5-2, 5-3, 5-4, 5-5, and 5-6. Tables 14-18 summarize various properties of the tested examples. The DSC Diagrams of Comparative Example 5-3 polypropylene foam and Examples 5-1, 5-2, 5-3, 5-5, and 5-6 are shown in FIGS. 8, 9, 10, 11, 12, and 13, respectively.

TABLE 12

| | ST866 | 5050 | NX8000 | NA11 | NAB-82 | FL7540L |
|---|---|---|---|---|---|---|
| Sample | (wt %) | (wt %) | (wt %) | (wt %) | (wt %) | (wt %) |
| Example | 99.85 | | | 0.05 | 0.1 | |
| 5-1 | | | | | | |
| Example | 99.9 | | | | 0.1 | |
| 5-2 | | | | | | |
| Example | 99.75 | | 0.05 | | 0.2 | |
| 5-3 | | | | | | |
| Example | 5 | 94.85 | | 0.05 | 0.1 | |
| 5-4 | | | | | | |
| Example | | 99.9 | | | 0.1 | |
| 5-5 | | | | | | |
| Example | | 5.2 | | | 0.1 | 94.7 |
| 5-6 | | | | | | |

TABLE 13

| | Specific value of each ingredient (wt %) | | | | |
|---|---|---|---|---|---|
| | | | | proportion | proportion |
| | | | | of | of |
| | C2 | | C4 | NX8000 | NAB-82 |
| Sample | content | C3 content | content | (α) | (β) |
| Example 5-2 | 2~4% | 95.9~97.9% | n.a. | — | 0.1% |
| (99.9% | | | | | |
| ST866 + | | | | | |
| 0.1% β) | | | | | |
| Example 5-3 | 2~4% | 95.75~97.75% | n.a. | 0.05% | 0.2% |
| (99.75% | | | | | |
| ST866 + | | | | | |
| 0.05% | | | | | |
| α + 0.2% β) | | | | | |
| Example 5-5 | 4.75% | 94.15% | 1% | — | 0.1% |
| (99.9% | | | | | |
| 5050 + | | | | | |
| 0.1% β) | | | | | |
| Example 5-6 | 1~2% | 91~93% | 6~7% | — | 0.1% |
| (94.7% | | | | | |
| FL7540L + | | | | | |
| 5.2% | | | | | |
| 5050 + | | | | | |
| 0.1% β) | | | | | |

TABLE 14

| | Polymer | Melting | | | |
|---|---|---|---|---|---|
| | Composition | Point | | | |
| | with or without | (° C.) | | Crystallization (%) | |
| Sample | nucleating agents | Tm1 | Tm2 | α | β |
| Comparative | Random | | | | |
| Example 5-1 | copolymer | | | | |
| (ST866) | | | | | |
| Comparative | Random | | | | |
| Example 5-2 | terpolymer | | | | |
| (FL7540L) | | | | | |
| Comparative | Terpolymer PP | 131 | — | 60.35 J/g | — |
| Example 5-3 | 5050 | | | 34.1% | |
| (5050) | | | | | |
| Example 5-1 | Random | 149 | — | 80.09 J/g | — |
| | copolymer | | | 45.2% | |
| | ST866 + α + β | | | | |
| Example 5-2 | Random | 153 | 136 | 17.11 J/g | 54.14 J/g |
| | copolymer | | | 9.7% | 32.1% |
| | ST866 + β | | | | |
| Example 5-3 | Random | 153 | 137 | 15.01 J/g | 26.92 J/g |
| | copolymer + α + β | | | 8.5% | 16.0% |
| Example 5-4 | Terpolymer PP | 135 | — | 56.88 J/g | — |
| | 5050 + α + β | | | 32.1% | |
| Example 5-5 | Terpolymer PP | 138 | 121 | 6.047 J/g | 26.31 J/g |
| | 5050 + β | | | 3.4% | 15.6% |
| Example 5-6 | Random | 142 | 129 | 6.659 J/g | 6.947 J/g |
| | terpolymer + β | | | 3.8% | 4.1% |

TABLE 15

| | MFR | Elong. | Elong. | Str. | | | IZOD | | | | |
|---|---|---|---|---|---|---|---|---|---|---|---|
| | g/10 | @YD | @BK | @YD | FM | HDT | @23° C. | Hardness | Shrinkage | Tm1 | Tm2 |
| Sample | min | % | % | Kg/cm² | Kg/cm² | ° C. | Kg-cm/cm | R Scale | % | ° C. | ° C. |
| Example | 7.28 | 11.6 | 510.1 | 270.7 | 9788 | 94 | 4.566 | 76.5 | 1.67 | 153 | 136 |
| 5-2 | | | | | | | | | | | |
| Example | 10.95 | 11.2 | >530.6 | 263.1 | 10102 | 88.1 | 10.513 | 83.33 | 1.77 | 153 | 137 |
| 5-3 | | | | | | | | | | | |
| Example | 5.16 | 15.0 | 476.7 | 192.7 | 5545 | 70.7 | 23.878 | 45.33 | 1.7 | 138 | 121 |
| 5-5 | | | | | | | | | | | |
| Example | 6.38 | 10.9 | >579.7 | 283.1 | 10767 | 81.1 | 6.487 | 87.42 | 1.62 | 142 | 129 |
| 5-6 | | | | | | | | | | | |

TABLE 16

| | | Pressure | | | | | Tensile | | Tear | |
|---|---|---|---|---|---|---|---|---|---|---|
| | Temp. | (kg/ | Time | Thickness | Density | Shrinkage | Strength | Elongation | Strength | Opening |
| Sample | (° C.) | cm²) | (min) | (mm) | (g/cm³) | (%) | (kPa) | @ break (%) | (kN/m) | Rate (%) |
| Comp. | 162.5/ | 144 | 30 | 18.18 | 0.085 | 0.15 | 331.2 | 0.22 | 3.16 | 19.88 |
| Example | 155 | | | | | | | | | |
| 5-1 | | | | | | | | | | |
| (ST866) | | | | | | | | | | |
| Comp. | 147.5 | 144 | 30 | 18.91 | 0.075 | 1.280 | 678.82 | 2.57 | 6.09 | 19.18 |
| Example | | | | | | | | | | |
| 5-2 | | | | | | | | | | |
| (FL7540L) | | | | | | | | | | |
| Example | 155 | 144 | 30 | 18.36 | 0.086 | 0.04 | 1292.61 | 8.88 | 7.28 | 7.90 |
| 5-3 | | | | | | | | | | |
| Example | 150 | 144 | 30 | 18.48 | 0.084 | 0.490 | 713.61 | 3.69 | 9.71 | 1.50 |
| 5-6 | | | | | | | | | | |

Elong. @YD: Elongation at yield; Str. @YD: Tensile strength at yield; FM: Flexural modulus; and HDT: Heat deflection temperature.

TABLE 17

| | | | Foam beads density (g/cm³) | | | |
|---|---|---|---|---|---|---|
| | | | Comparative | | Comparative | |
| Foaming conditions | | | Example 5-1 | | Example 5-2 | |
| Temp. | Pressure | Time | (ST866) | Example 5-3 | (FL7540L) | Example 5-6 |
| 120° C. | 144 kg/cm² | 30 min | 0.14 | | | |
| 117.5° C. | 144 kg/cm² | 30 min | 0.2 | 0.22 | | |
| 115° C. | 144 kg/cm² | 30 min | 0.61 | 0.32 | 0.19 | 0.13 |
| 110° C. | 144 kg/cm² | 30 min | | 0.44 | 0.25 | 0.18 |
| 105° C. | 144 kg/cm² | 30 min | | | 0.5~0.6 | 0.2~0.3 |
| 100° C. | 144 kg/cm² | 30 min | | | | 0.5~0.6 |

TABLE 18

| | | | Foam beads bonding strength and size | | | |
|---|---|---|---|---|---|---|
| | | | Comparative | | Comparative | |
| Foaming conditions | | | Example 5-1 | | Example 5-2 | |
| Temp. | Pressure | Time | (ST866) | Example 5-3 | (FL7540L) | Example 5-6 |
| 120° C. | 144 kg/cm² | 30 | Foam beads | | | |
| | | min | are big in the | | | |
| | | | foam part and | | | |
| | | | they can be | | | |
| | | | peeled off by | | | |
| | | | hand | | | |
| 117.5° C. | 144 kg/cm² | 30 | Foam beads | Foam beads | | |
| | | min | are big and | are small and | | |
| | | | can't be | can be bonded | | |
| | | | bonded | completely | | |
| 115° C. | 144 kg/cm² | 30 | Foam beads | Foam beads | Foam beads are | Foam beads are |
| | | min | are small and | are small in the | big in the foam | small and can be |
| | | | can't be | foam part and | part and they can | bonded |
| | | | bonded | they can be | be peeled off by | completely |
| | | | | peeled off by | hand | |
| | | | | hand | | |
| 110° C. | 144 kg/cm² | 30 | | Foam beads | Foam beads are | Foam beads are |
| | | min | | are small and | big in the foam | small and can be |
| | | | | can't be | part and they can | bonded |
| | | | | bonded | be peeled off by | completely |
| | | | | | hand | |
| 105° C. | 144 kg/cm² | 30 | | | Foam beads are | Foam beads are |
| | | min | | | big and can't be | small and can't be |
| | | | | | bonded | bonded |
| 100° C. | 144 kg/cm² | 30 | | | | Foam beads are |
| | | min | | | | small and can't be |
| | | | | | | bonded |

Results and Discussion

The results show (see, e.g., Table 14) that the Tin of Examples 5-2 (base of random copolymer of polypropylene) and 5-5 (base of random terpolymer of polypropylene) could be reduced down to approximately 136° C. and 121° C., respectively. For both Examples 5-2 and 5-5, two melting peaks (i.e., α and β crystals; Table 14) were observed. It is noted that for Example 5-5 the temperature range of the two melting peaks approached the operating window of the EPS foam beads (i.e., foaming temperature of EPS is about 100-120° C.—this target temperature is for the conventional steam foam molding, but not for the pellet direct foaming process).

It was further found that a low Tin can be kept by further adjusting the C2 and C4 content of random terpolymer of polypropylene and the proportion of α and β nucleating agents (see Tables 13 and 16). Surprisingly, it was further found that despite the low Tin the mechanical strength still increases (e.g., tensile strength, tear strength and elongation @ break) of the final foam parts (e.g., Examples 5-3 and 5-6; Table 16) at similar density range. In fact, the foam Examples 5-3 and 5-6 had higher tensile strength and elongation at break compared to those of existing commercial grades, Comparative Example 5-1 (ST866) and Comparative Example 5-2 (FL7540L) at similar density range.

As modified by nucleating agents, the foam shrinkage and open cell ratio were both quite low for Examples 5-3 and 5-6 compared to those of existing commercial grades, Comparative Example 5-1 (ST866) and Comparative Example 5-2 (FL7540L) at similar density range. This can further enhance the efficiency during foam product production and reduce the leakage problem when in contact with liquid products.

Thus, it was demonstrated that the foam beads made by Examples 5-3 and 5-6 can in fact get a similar or lower foam density and smaller foam beads at lower foaming temperature compared to those of Comparative Example 5-1 (ST866) and Comparative Example 5-2 (FL7540L) (see Tables 17 and 18). In addition, the bonding strength of the foam parts made by Examples 5-3 and 5-6 was very good compared to those of Comparative Example 5-1 (ST866) and Comparative Example 5-2 (FL7540L) that could not be bonded well during dry molding. It was further noted that for both Examples 5-5 and 5-6 the stiffness was increased by adjusting the C2 and C4 content. As an alternative to this approach (i.e., adjusting the C2 and C4 content), it was found that the addition of the α nucleating agent can be beneficial to increase stiffness in compositions containing random copolymer and the same C2 content (e.g., C2 content is 2˜4%; see Example 5-2—only β nucleating (i.e., NAB-82 (β) 0.1% by weight) agent versus Example 5-3—in which both an α and β nucleating agent were present (i.e., NX8000 (α) was 0.05% by weight and NAB-82 (β) was 0.2% by weight; see Table 13). The disclosed examples (e.g., Examples 5-2, 5-3, 5-5, and 5-6) achieved the goals of reducing the melting point, increasing modulus, and reducing energy costs.

### Example 6

The polypropylene resins and modifier formulations as provided in this example were well-mixed in a high speed Henschel mixer for 30 seconds. The mixtures (10 kg each) were then put into the hopper of a co-rotating twin-screw extruder (L/D: 37, KM Berstorff ZE40A) with the temperature set at 160˜180° C. and the screw rotational speed set at 260 rpm. The micro-pellets were then put into the hopper of injection molding machine (Chen Hsong Machinery, SM120V) with the temperature set at 170-220° C. to make the test specimens. Table 19 below provides a summary of the process conditions (i.e., temperature, time, and pressure) and the density of the resulting foamed, molded products.

TABLE 19

| | | | | | Crystallization | | | | | |
|---|---|---|---|---|---|---|---|---|---|---|
| | C2 | C4 | | | rate (%) | | Pressure | Temperature | Time | Density |
| Sample | % | % | Tm1 | Tm2 | α | β | (psi) | (° C.) | (min) | (g/cm³) |
| Example 6-1 | 0 | 4~6.5 | 155 | 139 | 8.354 J/g | 65.91 J/g | 2050 | 137.5 | 30 | 0.08~0.09 |
| 99.9% ST925 | | | | | 4.7% | 39.1% | | | | |
| (Random | | | | | | | | | | |
| copolymer) + | | | | | | | | | | |
| 0.1% β | | | | | | | | | | |
| Example 6-2 | 0 | 4~6.5 | 156 | 139 | 7.683 J/g | 60.63 J/g | 1770 | 140 | 30 | 0.08~0.09 |
| 99.85% ST925 | | | | | 4.3% | 36.0% | | | | |
| (Random | | | | | | | | | | |
| copolymer) + | | | | | | | | | | |
| 0.05% α + 0.1% | | | | | | | | | | |
| β | | | | | | | | | | |
| Example 6-3 | 0 | 4~6.5 | 151 | 138 | 7.133 J/g | 58.53 J/g | 2050 | 135 | 30 | 0.08~0.09 |
| 99.85% ST925 | | | | | 4.0% | 34.8% | | | | |
| (Random | | | | | | | | | | |
| copolymer) + | | | | | | | | | | |
| 0.05% α + 0.1% | | | | | | | | | | |
| β + EBA | | | | | | | | | | |
| 17BA04 | | | | | | | | | | |

Results and Discussion

The results show the foams formed by the ST925-based composition (Examples 6-1, 6-2 and 6-3) has low foaming density, and thus the foaming effect is good.

What is claimed is:

1. A polypropylene-based composition comprising:
(a) a random copolymer of polypropylene in an amount of 95.98% to 99.97% by weight of the polypropylene-based composition,
wherein the random copolymer of polypropylene is derived from monomers of propylene and one of ethylene and butylene; and
(b) at least one beta nucleating agent.

2. The polypropylene-based composition of claim 1, wherein the composition further comprises one or more alpha nucleating agents

3. The polypropylene-based composition of claim 1, wherein the at least one beta nucleating agent is present in an amount ranging from 0.01% to 2% by weight of the polypropylene-based composition.

4. The polypropylene-based composition of claim 2, wherein the one or more alpha nucleating agents are present in an amount ranging from 0.01% to 0.99% by weight of the polypropylene-based composition.

5. The polypropylene-based composition of claim 1, wherein the random copolymer of polypropylene is derived from monomers of propylene and ethylene, wherein ethylene is present in an amount ranging from 0.01% to 10% by weight of the random copolymer of polypropylene.

6. The polypropylene-based composition of claim 1, wherein the random copolymer of polypropylene is derived from monomers of propylene and butylene, wherein butylene is present in an amount ranging from 0.01% to 10% by weight of the random copolymer of polypropylene.

7. The polypropylene-based composition of claim 1, wherein the polypropylene-based composition has two melting points, a low melting point (Tm-low) of no less than 130° C. and a high melting point (Tm-high) of no more than 160° C.

8. The polypropylene-based composition of claim 1, wherein the composition further comprises a modifier.

9. The polypropylene-based composition of claim 1, wherein a melt flow rate of the random copolymer of polypropylene is in a ranged from 5 g/10 min to 10 g/10 min.

10. A polypropylene-based composition comprising:
(a) a random terpolymer of polypropylene in an amount of 94% to 99.97% by weight of the polypropylene-based composition,
wherein the random terpolymer of polypropylene is derived from monomers of propylene, ethylene, and butylene; and
(b) at least one beta nucleating agent.

11. The polypropylene-based composition of claim 10, wherein the at least one beta nucleating agent is present in an amount ranging from 0.01% to 2% by weight of the polypropylene-based composition.

12. The polypropylene-based composition of claim 10, wherein the composition further comprises one or more alpha nucleating agents in an amount ranging from 0.01% to 0.99% by weight of the polypropylene-based composition and less than the amount of beta nucleating agent.

13. The polypropylene-based composition of claim 10, wherein the ethylene is present in an amount ranging from 0.01% to 10% by weight of the random terpolymer of polypropylene, and butylene is present in an amount ranging from 0.01% to 10% by weight of the random terpolymer of polypropylene.

14. The polypropylene-based composition of claim 10, wherein the polypropylene-based composition has two melting points, a low melting point (Tm-low) of no less than 110° C. and a high melting point (Tm-high) of no more than 140° C.

15. The polypropylene-based composition of claim 10, wherein the composition further comprises a modifier.

16. A non-foamed micro-pellet formed from the polypropylene-based composition of claim 1 by an extrusion process.

17. A non-foamed micro-pellet formed from the polypropylene-based composition of claim 10 by an extrusion process.

18. The micro-pellet of claim 16, wherein the micro-pellet size is in a range of about 0.2 mm to about 2 mm.

19. The micro-pellet of claim 17, wherein the micro-pellet size is in a range of about 0.2 mm to about 2 mm.

20. A method for manufacturing polypropylene foam comprising:
a) extruding the polypropylene-based composition of claim 1 to form a non-foamed micro-pellet; and
b) foaming the non-foamed micro-pellet in a molding machine at a foaming pressure, a foaming temperature and a foaming time, wherein the foaming pressure is in a range from 144 psi to 2050 psi, the foaming temperature is between a first melting point and a second melting point of the polypropylene-based composition, and the foaming time is at least 5 minutes but not more than 30 minutes.

21. A method for manufacturing polypropylene foam comprising:
a) extruding the polypropylene-based composition of claim 10 to form a non-foamed micro-pellet; and
b) foaming the non-foamed micro-pellet in a molding machine at a foaming pressure, a foaming temperature and a foaming time, wherein the foaming pressure is in a range from 144 psi to 2050 psi, the foaming temperature is between a first melting point and a second melting point of the polypropylene-based composition, and the foaming time is at least 5 minutes but not more than 30 minutes.

22. The method of claim 20, wherein the molding machine is a batch physical foaming machine and the method directly molds the non-foamed polypropylene micro-pellet without a step of mixing in a liquid medium and without a step of steaming.

23. The method of claim 21, wherein the molding machine is a batch physical foaming machine and the method directly molds the non-foamed polypropylene micro-pellet without a step of mixing in a liquid medium and without a step of steaming.

24. A foamed, molded polypropylene produced by the method of claim 20 having the following characteristics:
a. a foam density of less than 0.2 g/cm³;
b. an optimal expansion ratio between 10 and 20; and
c. a stiffness of no less than 9000 kg/cm³.

25. A foamed, molded polypropylene produced by the method of claim 21 having the following characteristics:
a. a foam density of less than 0.2 g/cm³;
b. an optimal expansion ratio between 10 and 20; and
c. a stiffness of no less than 9000 kg/cm³.
